(19) United States
(12) Patent Application Publication
(10) Pub. No.: US 2021/0173318 A1
(43) Pub. Date: Jun. 10, 2021

(54) LIQUID DEVELOPER

(71) Applicant: KAO CORPORATION, Chuo-ku (JP)

(72) Inventors: Taiki YAMAMOTO, Osaka-shi (JP); Yuki WAKABAYASHI, Chiba-shi (JP)

(73) Assignee: KAO CORPORATION, Chuo-ku (JP)

(21) Appl. No.: 16/770,758

(22) PCT Filed: Dec. 26, 2018
(86) PCT No.: PCT/JP2018/047891

§ 371 Date: Jun. 8, 2020

(30) Foreign Application Priority Data
Dec. 26, 2017 (JP) 2017-250259
Dec. 26, 2017 (JP) 2017-250260

(51) Int. Cl. G03G 9/13; G03G 9/12; G03G 9/125

(52) U.S. Cl. CPC G03G 9/133; G03G 9/122; G03G 9/131; G03G 9/132; G03G 9/125

(57) ABSTRACT

The present invention relates to a liquid developer containing toner particles containing a colorant and a binder resin containing a polyester resin; and an insulating liquid, wherein the polyester resin includes a constituent unit derived from an alcohol component and a constituent unit derived from a carboxylic acid component, and the toner particles contain an acid-modified product A of a polymer of an α-olefin having 3 or more and 18 or less carbon atoms.

### FIELD OF THE INVENTION

The present invention relates to a liquid developer which is used for development of a latent image to be formed in, for example, an electrophotographic method, an electrostatic recording method, or an electrostatic printing method.

### BACKGROUND OF THE INVENTION

As a developer for electrophotography, a liquid developer in which toner particles composed of a material containing a colorant and a binder resin are dispersed in an insulating liquid is known. The liquid developer is excellent from the standpoint of image quality because it is possible to achieve micronization of the toner.

In general, for the liquid developer, a dispersant is used as a material for dispersing the toner particles in the insulating liquid. However, the toner particles and the dispersant are adsorbed on each other owing to a noncovalent interaction, and therefore, if an adsorption power is weak, an unadsorbed dispersant is produced. As a result, the resistance of the liquid developer is lowered, resulting in a reduction of printing quality.

JP 2007-219229 A (PTL 1) describes a method for producing a colored resin particle dispersion, including a step of polycondensing a polyester-forming monomer in a nonaqueous solvent, to obtain an unsaturated polyester; a step of graft polymerizing an ethylenically unsaturated monomer on the unsaturated polyester in a nonaqueous solvent, to prepare a modified polyester; and a step of dispersing a colorant and the modified polyester resin, to prepare a colored resin particle dispersion, the polycondensation and the graft polymerization being carried out at a temperature of 150° C. or lower. It is described that the foregoing colored resin particle dispersion is high in stability with time.

JP 2013-190657 A (PTL 2) describes a polyester resin composition for liquid developer, containing a polyester resin having a dodecenylsuccinic anhydride copolymerized therein and a colorant. It is described that according to the foregoing polyester resin composition, the affinity of toner particles with an insulating liquid is enhanced.

JP 2017-67861 A (PTL 3) describes a liquid developer including toner particles containing a polymer having an active hydrogen group and a polymer having a block isocyanate group and having a volume average particle diameter of 0.5 μm or more and 3 μm or less and a carrier liquid in which the toner particles are dispersed. It is described that according to the foregoing liquid developer, a toner image having low-temperature fixing property and high fixing strength is obtained.

### SUMMARY OF THE INVENTION

The present invention relates to the following liquid developer.

A liquid developer containing toner particles containing a colorant and a binder resin including a polyester resin; and an insulating liquid, wherein

the polyester resin includes a constituent unit derived from an alcohol component and a constituent unit derived from a carboxylic acid component, and

the toner particles contain an acid-modified product A of a polymer of an α-olefin having 3 or more and 18 or less carbon atoms.

### DETAILED DESCRIPTION OF THE INVENTION

When an unsaturated polyester is subjected to polymerization addition with a methacrylic monomer, a polymerization reaction between the unsaturated polyesters simultaneously proceeds, and therefore, the polyesters are crosslinked and gelated. As a result, though micronization can be achieved without adding a dispersant, there is involved such a defect that the liquid developer becomes high in viscosity, and the dispersion stability is lowered. On the other hand, there is encountered such a problem that when a dispersant is added in order to improve the dispersion stability, the resistance of the liquid developer becomes low, and the development characteristics are lowered. In addition, though toner particles composed of a polyester resin having a dodecenylsuccinic anhydride copolymerized therein are high in affinity with the insulating liquid, it was difficult to micronize and disperse the toner particles without adding a dispersant.

The liquid develop of a first embodiment of the present invention relates to a liquid developer capable of micronizing the toner particles and having low viscosity and high resistance.

In recent years, because of diversification of printing media, a liquid developer with excellent fixing property on a polypropylene film is demanded. For example, in PTL 3, it is mentioned that in printing on a printing medium, such as a polypropylene film, a liquid developer from which a toner image with high fixing strength is obtained is obtained, but more excellent fixing property on a polypropylene film is demanded.

The liquid developer of a second embodiment of the present invention relates to a liquid developer capable of micronizing the toner particles, having low viscosity, and having excellent fixing property on a polypropylene film.

The present invention relates to the following [1] to [3].

[1] A liquid developer containing toner particles containing a colorant and a binder resin including a polyester resin; and an insulating liquid, wherein

the polyester resin includes a constituent unit derived from an alcohol component and a constituent unit derived from a carboxylic acid component, and

the toner particles contain an acid-modified product A of a polymer of an α-olefin having 3 or more and 18 or less carbon atoms.

[2] A method for producing a printed matter, including a step of printing on a recording medium with a liquid developer, wherein

the liquid developer is the liquid developer as set forth in the above [1], and

the recording medium is a polypropylene film.

[3] Use of the liquid developer as set forth in the above [1] as a liquid developer for polypropylene film printing.

The first embodiment of the present invention is concerned with the liquid developer as set forth in the above [1], which is a liquid developer containing toner particles containing a colorant and a binder resin including a polyester resin; and an insulating liquid, wherein

the polyester resin includes a constituent unit derived from an alcohol component and a constituent unit derived from a carboxylic acid component including an acid-modified product A of a polymer of an α-olefin having 3 or more and 18 or less carbon atoms.

The second embodiment of the present invention is concerned with the liquid developer as set forth in the above [1], which is a liquid developer for polypropylene film printing, containing toner particles containing a binder, resin, an acid-modified polypropylene polymer, and a colorant; and an insulating liquid.

Here, the binder resin is preferably a resin having an acidic group, and more preferably a polyester resin.

In accordance with the present invention, a liquid developer capable of micronizing the toner particles and having low viscosity, and further having high resistance or excellent fixing property on a polypropylene film can be provided.

In accordance with the first embodiment of the present invention, a liquid developer capable of micronizing the toner particles and further having low viscosity and high resistance can be provided.

In accordance with the second embodiment of the present invention, a liquid developer capable of micronizing the toner particles and having low viscosity, and further having excellent fixing property on a polypropylene film can be provided.

### [Liquid Developer]

The liquid developer of the present invention (hereinafter also referred to simply as “liquid developer”) contains toner particles containing a colorant and a binder resin including a polyester resin (hereinafter also referred to simply as “polyester resin A”); and an insulating liquid.

The polyester resin A includes a constituent unit derived from an alcohol component and a constituent unit derived from a carboxylic acid component. In addition, the toner particles contain an acid-modified product A of a polymer of an α-olefin having 3 or more and 18 or less carbon atoms (hereinafter also referred to simply as “acid-modified product A”).

In accordance with the aforementioned constitutions, a liquid developer capable of micronizing the toner particles (hereinafter also referred to as simply as “micronization”) and having low viscosity (hereinafter also referred to as simply as “viscosity reduction”), and further having high resistance (hereinafter also referred to simply as “resistance increase”) or excellent fixing property on a polypropylene film is obtained. In particular, in accordance with the first embodiment of the present invention, a liquid developer capable of micronizing the toner particles and further having low viscosity and high resistance is obtained.

In accordance with the second embodiment of the present invention, a liquid developer capable of micronizing the toner particles and having low viscosity, and further having excellent fixing property on a polypropylene film (hereinafter also referred to as “PP film”) (fixing property will be hereinafter also referred to simply as “fixing property on PP film”) is obtained.

As for the liquid developer, though it is possible to micronize the toner particles, the polyester-base resin is high in polarity, and therefore, dispersion is instable in an insulating liquid. Then, in accordance with the first embodiment of the present invention, by compositing the polyester resin with a polymer of an α-olefin having 3 or more and 18 or less carbon atoms, the polyester resin which is excellent in dispersion stability even in the insulating liquid was obtained. Although the reason why such an effect is brought is not elucidated yet, it may be considered that there are causes that as compared with a linear-type aliphatic hydrocarbon chain, a branched-type aliphatic hydrocarbon chain derived from the acid-modified product A of a polymer of an α-olefin having 3 or more and 18 or less carbon atoms is low in crystallinity, and therefore, it is excellent in solubility in the insulating liquid; and that the aliphatic hydrocarbon chain is hardly bent, and therefore, it takes a structure where it spreads in the insulating liquid.

Although the reason why the liquid developer which is excellent in fixing property on the PP film is obtained according to the second embodiment of the present invention is not elucidated yet, the following may be considered.

Originally, an interaction which is needed for fixation hardly works between the binder resin represented by the polyester resin that is a high-polarity molecule and the PP film that is a low-polarity polymer. On the other hand, in the liquid developer according to the second embodiment of the present invention, the toner particles contain the acid-modified polypropylene polymer, and at least a polypropylene structure having the same structure as in the PP film is included in the toner particles. It may be considered that in view of the fact that at the time of fixing and heating in the printing, the polypropylene structure in the toner particles is oriented in the PP film direction, an adhesive power was generated owing to entanglement among the molecular chains.

In the light of the above, it may be considered that the acid-modified polypropylene polymer improves the adhesiveness to an interface between the PP film and the binder resin represented by the polyester resin, and therefore, the liquid developer with excellent fixing property on the PP film was obtained.

Definitions and the like of various terminologies in this specification are shown below.

The “carboxylic acid compound” is a concept including not only a carboxylic acid but also an anhydride which is decomposed during a reaction to produce an acid and an alkyl ester of a carboxylic acid (for example, the carbon number of the alkyl group is 1 or more and 3 or less).

In the case where the carboxylic acid compound is an alkyl ester of a carboxylic acid, the carbon number of the carboxylic acid is not counted into the carbon number of the alkyl group that is an alcohol residue of the ester.

The “binder resin” means a resin component which is contained in the toner including the polyester resin A.

The “volume median diameter (D50)” means a particle diameter to reach 50% of cumulative volume frequency of particle diameters calculated as volume fraction from smaller particles.

### <Toner Particles>

The toner particles contains a colorant and a binder resin including the polyester resin A. In addition, the toner particles contain the acid-modified product A of a polymer of an α-olefin having 3 or more and 18 or less carbon atoms.

Preferably, in the first embodiment of the present invention, the constituent unit derived from the carboxylic acid component of the polyester resin A includes the constituent unit derived from the acid-modified product A of a polymer of an α-olefin having 3 or more and 18 or less carbon atoms. That is, in the first embodiment, the acid-modified product A of a polymer of an α-olefin having 3 or more and 18 or less carbon atoms is included as a part of the constituent unit of the acid-modified product A included in the toner particles.

Preferably, in the second embodiment of the present invention, the toner particles contain the binder resin including the polyester resin A, the acid-modified product A of a polymer of an α-olefin having 3 or more and 18 or less carbon atoms, and the colorant. That is, preferably, in the second embodiment of the present invention, the toner particles contain, as a polymer different from the binder resin, the acid-modified product A of a polymer of an α-olefin having 3 or more and 18 or less carbon atoms.

### [Polyester Resin A]

Examples of the polyester resin A include a polyester resin and a polyester resin which is modified to an extent that its characteristics are not substantially impaired. In addition, the polyester resin A may be a composite resin containing a polyester resin segment and a vinyl resin segment.

Examples of the modified polyester resin include a urethane-modified polyester resin in which a constituent moiety derived from the polyester resin is modified with a urethane bond; and an epoxy-modified polyester resin in which a constituent moiety derived from the polyester resin is modified with an epoxy bond.

In the first embodiment of the present invention, the polyester resin A is preferably a resin including a constituent unit derived from an alcohol component and a constituent unit derived from a carboxylic acid component, in which the constituent unit derived from a carboxylic acid component includes a constituent unit derived from the acid-modified product A of a polymer of an α-olefin having 3 or more and 18 or less carbon atoms; and more preferably one in which the constituent unit derived from an alcohol component and the constituent unit derived from the acid-modified product A of a polymer of an α-olefin having 3 or more and 18 or less carbon atoms are connected with each other via an ester bond. The polyester resin which is used in the first embodiment of the present invention is hereinafter referred to as “polyester resin A1”.

In the second embodiment of the present invention, the polyester resin A is a resin including a constituent unit derived from an alcohol component and a constituent unit derived from a carboxylic acid component, and preferably one not including the constituent unit derived from the acid-modified product A of a polymer of an α-olefin having 3 or more and 18 or less carbon atoms. Preferably, in the second embodiment of the present invention, the toner particles contain a binder resin including the polyester resin A, the acid-modified product A of a polymer of an α-olefin having 3 or more and 18 or less carbon atoms, and a colorant. That is, in the second embodiment of the present invention, the polyester resin A does not include the constituent unit derived from the acid-modified product A of a polymer of an α-olefin having 3 or more and 18 or less carbon atoms, and the toner particles include, as a polymer different from the binder resin, the acid-modified product A of a polymer of an α-olefin having 3 or more and 18 or less carbon atoms. The polyester resin which is used in the second embodiment of the present invention is hereinafter referred to as “polyester resin A2”.

### (Polyester Resin A1)

The polyester resin A1 is used in the first embodiment of the present invention. From the viewpoint of obtaining a liquid developer which is excellent in micronization, viscosity reduction, and resistance increase, the polyester resin A1 includes a constituent unit derived from an alcohol component and a constituent unit derived from a carboxylic acid component, in which the constituent unit derived from a carboxylic acid component includes a constituent unit derived from the acid-modified product A of a polymer of an α-olefin having 3 or more and 18 or less carbon atoms.

In the polyester resin A1, though the acid-modified product A of a polymer of an α-olefin having 3 or more and 18 or less carbon atoms may be randomly incorporated into the polyester chain, or may be introduced into a terminal(s) of the polyester chain, the foregoing acid-modified product A is preferably randomly incorporated into the polyester chain.

Namely, the polyester resin A1 preferably has a comb-shaped polymer structure in which the acid-modified product A of a polymer of an α-olefin having 3 or more and 18 or less carbon atoms is grafted on the polyester resin.

Each of the components of the polyester resin A1 is hereunder described.

The alcohol component includes preferably an alkylene oxide adduct of bisphenol A, and more preferably an alkylene oxide adduct of bisphenol A represented by the formula (I):

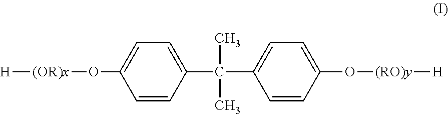

In the formula, OR and RO are each an oxyalkylene group; R is an ethylene group or a propylene group; x and y each stand for an average addition molar number of the alkylene oxide and are each a positive number; and a value of the sum of x and y is 1 or more, preferably 1.5 or more, and 16 or less, preferably 8 or less, and more preferably 4 or less.

Examples of the alkylene oxide adduct of bisphenol A represented by the formula (I) include a propylene oxide adduct of 2,2-bis(4-hydroxyphenyl)propane and an ethylene oxide adduct of 2,2-bis(4-hydroxyphenyl)propane. These may be used either alone or in combination of two or more thereof.

The content of the alkylene oxide adduct of bisphenol A in the alcohol component is preferably 70 mol % or more, more preferably 80 mol % or more, still more preferably 90 mol % or more, and yet still more preferably 95 mol % or more, and it is 100 mol % or less, and even yet still more preferably 100 mol %.

Examples of the other alcohol include aliphatic diols, such as ethylene glycol, 1,2-propanediol, 1,3-propanediol, 1,4-butanediol, 1,5-pentanediol, 1,6-hexanediol, 1,4-butenediol, 1,3-butanediol, and neopentyl glycol; and trihydric or higher hydric alcohols, such as glycerin.

The content of the other alcohol component is preferably 30 mol % or less, more preferably 20 mol % or less, still more preferably 10 mol % or less, yet still more preferably 5 mol % or less, and even yet still more preferably 0 mol %.

### (Acid-Modified Product a of Polymer of α-Olefin Having 3 or More and 18 or Less Carbon Atoms)

In the first embodiment of the present invention, from the viewpoint of obtaining a liquid developer which is excellent in micronization, viscosity reduction, and resistance increase, the carboxylic acid component constituting the polyester resin A1 includes the acid-modified product A of a polymer of an α-olefin having 3 or more and 18 or less carbon atoms.

The carbon number of the α-olefin is preferably 3 or more; it is preferably 18 or less, more preferably 10 or less, still more preferably 7 or less, yet still more preferably 4 or less; and it is even yet still more preferably 3. These may be used either alone or in combination of two or more thereof.

The polymer of an α-olefin having 3 or more and 18 or less carbon atoms may be a homopolymer of an α-olefin having 3 or more and 18 or less carbon atoms, may be a copolymer of two or more selected from α-olefins having 3 or more and 18 or less carbon atoms, or may be a copolymer of an α-olefin having 3 or more and 18 or less carbon atoms and other olefin. Examples of the polymer of the α-olefin having 3 or more and 18 or less carbon atoms include a polypropylene polymer, a polyisobutene polymer, a poly-1-butene polymer, a poly-1-pentene polymer, a poly-1-hexene polymer, a poly-1-octene polymer, a 4-methylpentene polymer, a 1-dodecene polymer, a 1-hexadecene polymer, and a propylene-hexene copolymer. Of these, a polypropylene polymer and a polyisobutene polymer are more preferred.

From the viewpoint of promoting the micronization, the viscosity reduction, and the resistance increase, the acid-modified product A is preferably an acid-modified product resulting from modification with maleic anhydride, fumaric anhydride, or itaconic anhydride, and more preferably an acid-modified product resulting from modification with maleic anhydride. Above all, an acid-modified polypropylene polymer resulting from modification with maleic anhydride at one terminal and an acid-modified polyisobutene polymer resulting from modification with maleic anhydride at one terminal are preferred.

### (Acid-Modified Polypropylene Polymer)

Examples of the polypropylene polymer before acid modification include polypropylene and a copolymer of propylene with other olefin.

Examples of the polypropylene include polypropylene obtained according to a method of polymerization of ordinary propylene; a method of thermally decomposing polypropylene for ordinary molding, which is used for containers and others; and a method of separating and purifying a low-molecular polypropylene that is formed as a by-product at the time of producing polypropylene for use for containers and others for ordinary molding.

Examples of the copolymer of propylene with other olefin include a copolymer obtained through polymerization of propylene with other olefin having an unsaturated bond capable of copolymerizing with propylene. The copolymer may be any of a random copolymer and a block copolymer.

Examples of the other olefin include ethylene and an olefin having 4 or more and 10 or less carbon atoms. Examples of the other olefin include ethylene, butene, pentene, hexene, and 2-ethylhexene.

In the case of the copolymer, a proportion of propylene is preferably 60% by mass or more, more preferably 80% by mass or more, and still more preferably 90% by mass or more, and it is less than 100% by mass.

Examples of the acid-modified polypropylene polymer include an oxidized polypropylene polymer; and a polypropylene polymer resulting from modification with a carboxylic acid compound having an unsaturated bond or its anhydride.

Examples of the oxidized polypropylene polymer include an oxidized polypropylene polymer obtained by imparting a carboxy group to a polypropylene polymer structure by a method, such as air oxidation.

Examples of the polypropylene polymer resulting from modification with a carboxylic acid compound having an unsaturated bond or its anhydride include a polypropylene polymer resulting from random graft modification with a carboxylic acid compound having an unsaturated bond or its anhydride (hereinafter also referred to simply as “random graft-modified polypropylene polymer”); and a polypropylene polymer resulting from terminal modification with a carboxylic acid compound having an unsaturated bond or its anhydride (hereinafter also referred to simply as “terminally modified polypropylene polymer”).

Examples of the carboxylic acid compound having an unsaturated bond or its anhydride include maleic anhydride, fumaric acid, and itaconic acid. Of these, maleic anhydride is preferred. By introducing a maleic anhydride moiety into the polypropylene polymer, the two constituent moieties derived from the polyester resin each can be connected through an ester bond. In particular, by using a maleic anhydride terminally modified polypropylene polymer, it may be considered that a polyester resin having a structure in which the two constituent moieties derived from the polyester resin are connected to the terminal can be obtained owing to the terminal maleic anhydride moiety of the polypropylene polymer. For that reason, by using the polypropylene polymer modified with maleic anhydride, it may be considered that the fixing property on the polypropylene film is improved, and the low-temperature fixing property and storage performance of the toner are enhanced.

The random graft-modified polypropylene polymer is preferably a polypropylene polymer which is randomly grafted and modified with maleic anhydride (hereinafter also referred to as “randomly grafted maleic anhydride-modified polypropylene polymer”).

As for the randomly grafted maleic anhydride-modified polypropylene polymer, the polypropylene polymer is preferably grafted and modified with one or more maleic anhydrides in one molecule thereof. Whether or not the modification with maleic anhydride is made can be prescribed by means of a general spectral measurement. When the modification with maleic anhydride is made, a double bond of maleic anhydride changes to a single bond, and therefore, the modification can be prescribed by measuring a spectral change thereof.

The random graft-modified polypropylene polymer is, for example, obtained by generating a radical in a polypropylene polymer molecule and allowing to react with the carboxylic acid compound having an unsaturated bond or its anhydride.

As commercially available products of the random graft-modified polypropylene polymer, examples of the randomly grafted maleic anhydride-modified polypropylene polymer include “M-100”, “M-300”, “M-310”, “PMA H1000A”, “PMA H1100A”, “PMA H3000A”, “PMA-T”, “PMA-F2”, and “PMA-L” of “TOYO-TAC” Series (all of which are available from Toyobo Co., Ltd.); “1001”, “1010”, “100TS”, and “110TS” of “UMEX” Series (all of which are available from Sanyo Chemical Industries, Ltd.); and “003” and “006” of “KAYABRID” Series (all of which are available from Akzo Nobel N.V.).

The terminally modified polypropylene polymer is preferably a polypropylene polymer in which one terminal thereof is modified with maleic anhydride (hereinafter also referred to as “polypropylene polymer terminally modified with maleic anhydride at one terminal”).

As for the polypropylene polymer terminally modified with maleic anhydride at one terminal, the polypropylene polymer is preferably modified with one maleic anhydride in one molecule thereof. Whether or not the modification with maleic anhydride is made can be prescribed by means of a general spectral measurement. When the modification with maleic anhydride is made, a double bond of maleic anhydride changes to a single bond, and therefore, the modification can be prescribed by measuring a spectral change thereof. Since a portion to be connected at the polypropylene side also causes a spectral change before and after bonding, the modification can also be prescribed by measuring this.

The terminally modified polypropylene polymer at one terminal is, for example, obtained by subjecting a polypropylene polymer having an unsaturated bond at one terminal thereof to an Ene reaction with a carboxylic acid compound having an unsaturated bond or its anhydride. Although the polypropylene polymer having an unsaturated bond at one terminal thereof is obtained by a known method, for example, it can be produced by using a vanadium catalyst, a titanium catalyst, a zirconium catalyst, or the like.

Examples of the acid-modified polypropylene polymer include a polypropylene having maleic anhydride randomly graft-modified thereon; a copolymer of propylene having maleic anhydride randomly graft-modified thereon with other olefin; a polypropylene in which one terminal thereof is modified with maleic anhydride (hereinafter also referred to as “maleic anhydride-modified polypropylene at one terminal”); and a copolymer of propylene in which one terminal thereof is modified with maleic anhydride with other olefin (hereinafter also referred to as “propylene copolymer terminally modified with maleic anhydride at one terminal”).

Of these, a polypropylene terminally modified with maleic anhydride at one terminal and a propylene copolymer terminally modified with maleic anhydride at one terminal are preferred.

### (Acid-Modified Polyisobutene Polymer)

Examples of the polymer of the acid-modified polyisobutene polymer before acid modification include polyisobutene and a copolymer of isobutene with other olefin. Examples of the other olefin include the same as those exemplified in the aforementioned acid-modified polypropylene polymer.

In the case of the copolymer, a proportion of isobutene is preferably 60% by mass or more, more preferably 80% by mass or more, and still more preferably 90% by mass or more, and it is less than 100% by mass.

Examples of the acid-modified polyisobutene polymer include an oxidized polyisobutene polymer; and a polyisobutene polymer resulting from modification with a carboxylic acid compound having an unsaturated bond or its anhydride.

Of these, a polyisobutene polymer resulting from modification with a carboxylic acid compound having an unsaturated bond or its anhydride is preferred.

Examples of the polyisobutene polymer resulting from modification with a carboxylic acid compound having an unsaturated bond or its anhydride include a polyisobutene polymer resulting from random graft modification with a carboxylic acid compound having an unsaturated bond or its anhydride (hereinafter also referred to simply as “random graft-modified polyisobutene polymer”); and a polyisobutene polymer resulting from terminal modification with a carboxylic acid compound having an unsaturated bond or its anhydride (hereinafter also referred to simply as “terminally modified polyisobutene polymer”).

Of these, a terminally modified polyisobutene polymer is preferred.

The terminally modified polyisobutene polymer is preferably a polypropylene polymer in which one terminal thereof is modified with maleic anhydride (hereinafter also referred to as “polypropylene polymer terminally modified with maleic anhydride at one terminal”).

### (Physical Properties of Acid-Modified Product A)

From the viewpoint of promoting the micronization and the viscosity reduction, a melting point of the acid-modified product A is preferably −30° C. or higher, more preferably −10° C. or higher, still more preferably 0° C. or higher, yet still more preferably 30° C. or higher, even yet still more preferably 50° C. or higher, and even still more preferably 70° C. or higher, and it is preferably 170° C. or lower, more preferably 150° C. or lower, still more preferably 130° C. or lower, and yet still more preferably 100° C. or lower.

From the viewpoint of promoting the micronization and the viscosity reduction, an acid value of the acid-modified product A is preferably 500 mgKOH/g or less, more preferably 300 mgKOH/g or less, still more preferably 200 mgKOH/g or less, and yet still more preferably 150 mgKOH/g or less, and it is preferably 10 mgKOH/g or more, more preferably 30 mgKOH/g or more, still more preferably 50 mgKOH/g or more, and yet still more preferably 70 mgKOH/g or more.

The measurement methods of the melting point and the acid value are those as measured by the methods described in the section of Examples.

A number average molecular weight of the acid-modified product A is preferably 200 or more, more preferably 400 or more, still more preferably 600 or more, yet still more preferably 800 or more, and even yet still more preferably 1,000 or more, and it is preferably 50,000 or less, more preferably 30,000 or less, still more preferably 15,000 or less, yet still more preferably 8,000 or less, and even yet still more preferably 3,000 or less.

The number average molecular weight is measured using polystyrene as a standard sample by means of gel permeation chromatography.

In the first embodiment of the present invention, from the viewpoint of promoting the micronization, the viscosity reduction, and the resistance increase, the content of the acid-modified product A in the carboxylic acid component is preferably 1 mol % or more, more preferably 2 mol % or more, and still more preferably 5 mol % or more, and it is preferably 40 mol % or less, more preferably 30 mol % or less, still more preferably 20 mol % or less, and yet still more preferably 10 mol % or less.

In the first embodiment of the present invention, from the viewpoint of promoting the micronization, the viscosity reduction, and the resistance increase, the amount of the constituent unit derived from the acid-modified product Ain the polyester resin A1 is preferably 1% by mass or more, more preferably 3% by mass or more, still more preferably 5% by mass or more, yet still more preferably 7% by mass or more, and even yet still more preferably 10% by mass or more, and it is preferably 40% by mass or less, more preferably 35% by mass or less, still more preferably 30% by mass or less, and yet still more preferably 25% by mass or less.

Examples of other carboxylic acid component include an aromatic dicarboxylic acid compound, other aliphatic dicarboxylic acid compound, and a tribasic or higher carboxylic acid compound.

Of these, an aromatic dicarboxylic acid compound is preferably included in the carboxylic acid component.

Examples of the aromatic dicarboxylic acid compound include phthalic acid, isophthalic acid, and terephthalic acid. Of these, at least one selected from terephthalic acid and isophthalic acid is more preferred, and terephthalic acid is still more preferred.

From the viewpoint of low-temperature fixing property, the content of the aromatic dicarboxylic acid compound in the carboxylic acid component is preferably 20 mol % or more, more preferably 40 mol % or more, still more preferably 60 mol % or more, and yet still more preferably 80 mol % or more, and it is preferably 99 mol % or less, and more preferably 98 mol % or less.

Examples of the aliphatic dicarboxylic acid compound include aliphatic dicarboxylic acids, such as oxalic acid, malonic acid, maleic acid, fumaric acid, citraconic acid, itaconic acid, glutaconic acid, succinic acid which may be substituted with an alkyl group having 1 or more and 20 or less carbon atoms or an alkenyl group having 2 or more and 20 or less carbon atoms, and adipic acid.

The succinic acid which is substituted with a linear alkyl group having 1 or more and 20 or less carbon atoms or a linear alkenyl group having 2 or more and 20 or less carbon atoms is preferably succinic acid substituted with a linear alkyl group or a linear alkenyl group each having 6 or more and 14 or less carbon atoms, and more preferably succinic acid substituted with a linear alkyl group or a linear alkenyl group each having 8 or more and 12 or less carbon atoms. Specifically, examples thereof include n-octylsuccinic acid and n-dodecenylsuccinic acid (n-tetrapropenylsuccinic acid).

Examples of the tribasic or higher carboxylic acid compound include 1,2,4-benzenetricarboxylic acid (trimellitic acid), 2,5,7-naphthalenetricarboxylic acid, and pyromellitic acid. Of these, trimellitic acid or its acid anhydride (hereinafter also referred to as “trimellitic acid compound”) is preferred.

The alcohol component may appropriately contain a monohydric alcohol, and the carboxylic acid compound may appropriately contain a monovalent carboxylic acid compound.

An equivalent ratio of the carboxy group of the carboxylic acid component to the hydroxy group of the alcohol component [(COOH group)/(OH group)] is preferably 0.7 or more, and more preferably 0.8 or more, and it is preferably 1.3 or less, more preferably 1.0 or less, and still more preferably 0.9 or less.

### (Production Method of Polyester Resin A1)

The polyester resin A1 is, for example, obtained by

(a) polycondensing a raw material monomer including the alcohol component and the carboxylic acid component including the acid-modified compound A, or

(b) allowing the polyester resin that is a polycondensate between the alcohol component and the other carboxylic acid component than the acid-modified product A (hereinafter also referred to as “other carboxylic acid component”) to react with the acid-modified product A.

Examples of the aforementioned reaction include dehydration condensation and ester interchange reaction.

As the reaction condition, a condition under which a carboxylic acid group or anhydrous carboxylic acid group of the acid-modified product A, the alcohol component, the other carboxylic acid component, and so on undergo the dehydration condensation or ester interchange is preferred.

In detail, examples of a method of obtaining the polyester resin A include

(i) a method in which the acid-modified product A is allowed to exist from the initial stage of reaction, and the raw material monomer inducing the alcohol component and the carboxylic acid component is subjected to polycondensation;

(ii) a method in which the acid-modified product A is allowed to exist on the way of the reaction, and the raw material monomer including the alcohol component and the carboxylic acid component is subjected to polycondensation;

(iii) a method in which the raw material monomer including the alcohol component and the other carboxylic acid component is subjected to polycondensation, and then, the acid-modified product A is allowed to exist; and

(iv) a method in which the polyester resin that is a polycondensate between the alcohol component and the other carboxylic acid component is dissolved under heat, and the acid-modified product A is allowed to exist under a condition at a temperature 180° C. or higher and 250° C. or lower.

Of these, the method (i) is preferred from the viewpoint of enhancing the dispersion stability of the toner particles and improving the micronization, the viscosity reduction, and the resistance increase.

### (Polyester Resin A2)

The polyester resin A2 is used in the second embodiment of the present invention. The polyester resin A2 includes a constituent unit derived from an alcohol component and a constituent unit derived from a carboxylic acid component. The alcohol component is the same as the alcohol component described with respect to the polyester resin A1, and a preferred range thereof is also the same. The carboxylic acid component is the same as the carboxylic acid component described with respect to the polyester resin A1 except for the matter that the acid-modified product A is not included, and a preferred range thereof is also the same.

### (Composite Particles)

Next, the composite resin is described.

The composite resin has a polyester resin segment and a vinyl resin segment.

The polyester resin segment is preferably composed of the aforementioned polyester resin.

The vinyl resin segment is preferably composed of an addition polymer of a raw material including a styrene compound, and preferably composed of an addition polymer of a raw material monomer containing a styrene compound and a vinyl monomer having an aliphatic hydrocarbon group having 3 or more and 22 or less carbon atoms.

Examples of the styrene compound include substituted or unsubstituted styrenes. Examples of the substituent include an alkyl group having 1 or more and 5 or less carbon atoms, a halogen atom, an alkoxy group having 1 or more and 5 or less carbon atoms, and a sulfonic acid group or its salt.

Examples of the styrene compound include styrenes, such as styrene, methylstyrene, α-methylstyrene, ß-methylstyrene, tert-butylstyrene, chlorostyrene, methoxystyrene, and a styrenesulfonic acid or its salt. Of these, styrene is preferred.

The content of the styrene compound, preferably styrene in a raw material monomer of the vinyl resin segment is preferably 50% by mass or more, more preferably 70% by mass or more, and still more preferably 80% by mass or more from the viewpoint of improvement in dispersion stability of the toner particles and improvement in storage stability, and it is preferably 95% by mass or less, more preferably 93% by mass or less, and still more preferably 90% by mass or less from the viewpoint of improvement in low-temperature fixing property of the toner and viewpoint of wet pulverization property.

From the viewpoint of low-temperature fixing property, high-temperature offset resistance, and improvement in durability of the toner, the carbon number of the hydrocarbon group of the vinyl monomer having an aliphatic hydrocarbon group is preferably 3 or more, more preferably 4 or more, and still more preferably 6 or more, and it is preferably 22 or less, more preferably 20 or less, and still more preferably 18 or less.

Examples of the aliphatic hydrocarbon group include an alkyl group, an alkynyl group, and an alkenyl group. Of these, an alkyl group or an alkenyl group is preferred, and an alkyl group is preferred. The aliphatic hydrocarbon group may be either branched or linear.

The vinyl monomer having the aliphatic hydrocarbon group is preferably a (meth)acrylic acid alkyl ester. In the case of an alkyl ester of (meth)acrylic acid, the hydrocarbon group is an alcohol-side residue of the ester.

Examples of the (meth)acrylic acid alkyl ester include methyl (meth)acrylate, ethyl (meth)acrylate, (iso)propyl (meth)acrylate, 2-hydroxyethyl (meth)acrylate, (iso- or tert-)butyl (meth)acrylate, 2-ethylhexyl (meth)acrylate, (iso)octyl (meth)acrylate, (iso)decyl (meth)acrylate, and (iso)stearyl (meth)acrylate. These are preferably used alone or in combination of two or more thereof. Here, with respect to the terms “(iso- or tert-)” and “(iso)”, these prefixes mean include both the case where they are existent and the case where they are not existent, and the case where such a prefix is existent expresses “normal”. In addition, the term “(meth)acrylate” is at least one selected from acrylate and methacrylate.

From the viewpoint of low-temperature fixing property, high-temperature offset resistance, and improvement in durability of the toner, the amount of the vinyl monomer having an aliphatic hydrocarbon group having 3 or more and 22 or less carbon atoms in the raw material monomer of the vinyl resin segment is preferably 5% by mass or more, more preferably 10% by mass or more, and still more preferably 15% by mass or more, and it is preferably 50% by mass or less, more preferably 35% by mass or less, and still more preferably 25% by mass or less.

Examples of the other raw monomer include ethylenically unsaturated monoolefins, such as ethylene and propylene; conjugated dienes, such as butadiene; halovinyls, such as vinyl chloride; vinyl esters, such as vinyl acetate and vinyl propionate; (meth)acrylic acid aminoalkyl esters, such as dimethylaminoethyl (meth)acrylate; vinyl ethers, such as methyl vinyl ether; vinylidene halides, such as vinylidene chloride; and N-vinyl compounds, such as N-vinylpyrrolidone.

From the viewpoint of low-temperature fixing property, high-temperature offset resistance, and improvement in durability of the toner, the total amount of the styrene compound and the vinyl monomer having an aliphatic hydrocarbon group having 3 or more and 22 or less carbon atoms in the raw material monomer in the vinyl resin segment is 80% by mass or more, more preferably 90% by mass or more, and still more preferably 95% by mass or more, and it is 100% by mass or less, and preferably 100% by mass.

In order to connect the polyester resin segment and the vinyl resin segment with each other, the composite resin has a constituent unit derived from a bireactive monomer having the polyester resin segment and the vinyl resin segment bound thereto via a covalent bond.

The “constituent unit derived from a bireactive monomer” means a unit in which the functional group of the bireactive monomer reacts with the vinyl moiety.

Examples of the bireactive monomer include a vinyl monomer having at least one functional group selected from a hydroxy group, a carboxy group, an epoxy group, a primary amino group, and a secondary amino group in a molecule thereof. Of these, a vinyl monomer having a hydroxy group or a carboxy group is preferred, and a vinyl monomer having a carboxy group is more preferred from the viewpoint of reactivity.

Examples of the bireactive monomer include acrylic acid, methacrylic acid, fumaric acid, and maleic acid. Of these, acrylic acid or methacrylic acid is preferred, and acrylic acid is more preferred from the viewpoint of reactivity with both polycondensation reaction and addition polymerization reaction.

The amount of the constituent unit derived from the bireactive monomer is preferably 1 part by mol or more, more preferably 5 parts by mol or more, and still more preferably 8 parts by mol or more, and it is preferably 30 parts by mol or less, more preferably 25 parts by mol or less, and still more preferably 20 parts by mol or less, based on 100 parts by mol of the alcohol component of the polyester resin segment of the composite resin (A).

From the viewpoint of low-temperature fixing property, high-temperature offset resistance, and improvement in durability of the toner, the amount of the polyester resin segment in the composite resin is preferably 40% by mass or more, more preferably 50% by mass or more, still more preferably 60% by mass or more, yet still more preferably 70% by mass or more, and even yet still more preferably 75% by mass or more, and it is preferably 95% by mass or less, more preferably 85% by mass or less, and still more preferably 80% by mass or less.

From the viewpoint of low-temperature fixing property, high-temperature offset resistance, and improvement in durability of the toner, the amount of the vinyl resin segment in the composite resin is preferably 10% by mass or more, more preferably 15% by mass or more, and still more preferably 20% by mass or more, and it is preferably 60% by mass or less, more preferably 50% by mass or less, still more preferably 40% by mass or less, and yet still more preferably 30% by mass or less.

From the viewpoint of low-temperature fixing property, high-temperature offset resistance, and improvement in durability of the toner, the amount of the constituent unit derived from the bireactive monomer in the composite resin is preferably 0.1% by mass or more, more preferably 0.5% by mass or more, and still more preferably 0.8% by mass or more, and it is preferably 10% by mass or less, more preferably 5% by mass or less, and still more preferably 3% by mass or less.

From the viewpoint of low-temperature fixing property, high-temperature offset resistance, and improvement in durability of the toner, the total amount of the polyester resin segment and the vinyl resin segment in the composite resin and the constituent unit derived from the bireactive monomer is preferably 80% by mass or more, more preferably 90% by mass or more, still more preferably 93% by mass or more, and yet still more preferably 95% by mass or more, and it is 100% by mass or less, and preferably 99% by mass or less.

A mass ratio of the vinyl resin segment to the polyester resin segment [(vinyl resin segment)/(polyester resin segment)] in the composite resin is preferably 3/97 or more, more preferably 7/93 or more, and still more preferably 10/90 or more from the viewpoint of pulverization property of the toner particles, and it is preferably 45/55 or less, more preferably 40/60 or less, still more preferably 35/65 or less, yet still more preferably 30/70 or less, and even yet still more preferably 25/75 or less from the viewpoint of dispersion stability of the toner particles.

The aforementioned amounts are calculated on the basis of the ratios of the amounts of the raw material monomer of the polyester resin segment and the vinyl resin segment, the bireactive monomer, and a polymerization initiator, with the proviso that the amount of water due to dehydration in polycondensation for the polyester resin segment, etc. In the case of using a polymerization initiator, the mass of the polymerization initiator is calculated including in the vinyl resin

### Segment.

### (Production Method of Polyester Resin A2)

The polyester resin A2 is, for example, obtained through polycondensation a raw material monomer including the alcohol component and the carboxylic acid component.

In producing the polyester resin A (including both the polyester resins A1 and A2), the polycondensation between the alcohol component and the carboxylic acid component can be, for example, performed in an inert gas atmosphere optionally in the presence of an esterification catalyst, a polymerization inhibitor, etc. at a temperature of 180° C. or higher and 250° C. or lower. Examples of the esterification catalyst include tin compounds, such as dibutyltin oxide and tin(II) 2-ethylhexanoate; and titanium compounds, such as titanium diisopropylate bistriethanol aminate. Examples of an esterification promoter which is used together with the esterification catalyst include gallic acid. The amount of the esterification catalyst used is preferably 0.01 parts by mass or more, and more preferably 0.1 parts by mass or more, and it is preferably 1 part by mass or less, and more preferably 0.8 parts by mass or less, based on 100 parts by mass of the total amount of the alcohol component and the carboxylic acid component. The amount of the esterification promoter used is preferably 0.001 parts by mass or more, and more preferably 0.01 parts by mass or more, and it is preferably 0.5 parts by mass or less, and more preferably 0.1 parts by mass or less, based on 100 parts by mass of the total amount of the alcohol component and the carboxylic acid component.

In the polyester resin A1 which is used in the first embodiment of the present invention, the temperature at which the acid-modified product A is allowed to react is preferably 180° C. or higher, more preferably 190° C. or higher, and still more preferably 200° C. or higher, and it is preferably 250° C. or lower, more preferably 240° C. or lower, and still more preferably 235° C. or lower.

In the case where the polyester resin A (including both the polyester resins A1 and A2) is a composite resin, for example, there are the following methods (1) to (3) including polycondensation owing to the alcohol component and the carboxylic acid component and addition polymerization owing to the raw material monomer of the vinyl resin segment and the bireactive monomer.

(1) A method in which after polycondensation owing to the alcohol component and the carboxylic acid component, addition polymerization owing to the raw material monomer of the vinyl resin segment and the bireactive monomer is performed.

(2) A method in which after addition polymerization owing to the raw material of the vinyl resin segment and the bireactive monomer, polycondensation owing to the alcohol component and the carboxylic acid component is performed.

(3) A method in which polycondensation owing to the alcohol component and the carboxylic acid component and addition polymerization owing to the raw material monomer of the vinyl resin segment and the bireactive monomer are performed in parallel with each other.

All of the polycondensation and the addition polymerization in the aforementioned methods (1) to (3) are preferably performed in the same vessel.

It is preferred to produce the composite resin by the aforementioned method (1) or (2) from the standpoint that a degree of freedom regarding the reaction temperature of the polycondensation reaction, and the method (1) is more preferred.

The condition of the aforementioned polycondensation is the same as mentioned above.

In the addition polymerization, the raw material monomer of the vinyl resin segment and the bireactive monomer are subjected to addition polymerization.

The temperature of the addition polymerization is preferably 110° C. or higher, and more preferably 130° C. or higher, and it is preferably 220° C. or lower, and more preferably 200° C. or lower. In addition, it is preferred to promote the reaction by reducing the pressure of the reaction system in the latter half of the polymerization.

As a polymerization initiator for the addition polymerization, a known polymerization initiator, for example, a peroxide, such as di-tert-butyl peroxide, a persulfate, such as sodium persulfate, and an azo compound, such as 2,2′-azobis(2,4-dimethylvaleronitrile), can be used.

The amount of the polymerization initiator used is preferably 1 part by mass or more, more preferably 3 parts by mass or more, and still more preferably 5 parts by mass or more, and it is preferably 20 parts by mass or less, more preferably 15 parts by mass or less, and still more preferably 10 parts by mass or less, based on 100 parts by mass of the raw material monomer of the vinyl resin segment.

### (Physical Properties of Polyester Resin A)

A softening point of the polyester resin A (including both the polyester resins A1 and A2) is preferably 80° C. or higher, and more preferably 85° C. or higher, and it is preferably 170° C. or lower, and more preferably 150° C. or lower.

A glass transition temperature of the polyester resin A (including both the polyester resins A1 and A2) is preferably 40° C. or higher, and more preferably 50° C. or higher, and it is preferably 80° C. or lower, more preferably 70° C. or lower, still more preferably 65° C. or lower, and yet still more preferably 62° C. or lower.

An acid value of the polyester resin A1 is preferably 1 mgKOH/g or more, and more preferably 2 mgKOH/g or more, and it is preferably 30 mgKOH/g or less, more preferably 20 mgKOH/g or less, and still more preferably 10 mgKOH/g or less.

A hydroxyl value of the polyester resin A2 is preferably 10 mgKOH/g or more, more preferably 20 mgKOH/g or more, still more preferably 30 mgKOH/g or more, and yet still more preferably 40 mgKOH/g or more, and it is preferably 70 mgKOH/g or less, more preferably 60 mgKOH/g or less, and still more preferably 55 mgKOH/g or less.

In the case where the polyester resin A is composed of two or more polyesters, it is preferred that the aforementioned physical properties of the polyester resin A fall within the aforementioned range in terms of a weighted average value thereof.

(Binder Resin Other than Polyester Resin A)

The toner particles in the present invention may contain other binder resin than the polyester resin A.

Examples of the other binder resin include a styrene resin, an epoxy resin, rosin-modified maleic acid resin, a polyethylene resin, a polypropylene resin, a polyurethane resin, a silicone resin, a phenol resin, and an aliphatic or alicyclic hydrocarbon resin.

The content of the polyester resin A in the binder resin is preferably 60% by mass or more, more preferably 80% by mass or more, still more preferably 90% by mass or more, and yet still more preferably 95% by mass or more, and it is 100% by mass or less, and preferably 100% by mass.

### [Acid-Modified Product a of Polymer of α-Olefin Having 3 or More and 18 or Less Carbon Atoms]

Preferably, in the second embodiment of the present invention, the toner particles contain the binder resin including the polyester resin A, the acid-modified propylene polymer, and the colorant. That is, preferably, in the second embodiment of the present invention, the toner particles include, as a polymer different from the binder resin, the acid-modified product A of a polymer of an α-olefin having 3 or more and 18 or less carbon atoms.

The acid-modified product A of a polymer of an α-olefin having 3 or more and 18 or less carbon atoms is the same as described above, and a preferred range thereof is also the same.

In the second embodiment of the present invention, from the viewpoint of improvement in fixing property on PP and the viewpoint of promoting the micronization and the viscosity reduction, the amount of the acid-modified product A of a polymer of an α-olefin having 3 or more and 18 or less carbon atoms to be contained in the toner particles is preferably 1 part by mass or more, more preferably 5 parts by mass or more, and still more preferably 10 parts by mass or more, and it is preferably 40 parts by mass or less, more preferably 30 parts by mass or less, and still more preferably 20 parts by mass or less, based on 100 parts by mass of the binder resin.

### [Colorant]

The colorant can be any of a dye, a pigment, and the like, which are used as a colorant for toner, with a pigment being preferred.

Specifically, examples thereof include carbon black, phthalocyanine blue, permanent brown FG, brilliant fast scarlet, pigment green B, rhodamine-B base, solvent red 49, solvent red 146, solvent blue 35, quinacridone, carmine 6B, isoindoline, and disazo yellow. The toner particles may be any of a black toner and other color toner.

In the toner particles, the content of the colorant is preferably 5 parts by mass or more, more preferably 10 parts by mass or more, and still more preferably 15 parts by mass or more, and it is preferably 100 parts by mass or less, more preferably 70 parts by mass or less, still more preferably 50 parts by mass or less, and yet still more preferably 30 parts by mass or less, based on 100 parts by mass of the binder resin.

### [Additives]

The toner particles may contain additives, such as a release agent, a charge controlling agent, a charge controlling resin, a magnetic powder, a fluidity enhancer, a conductivity controlling agent, a reinforcing filler, such as a fibrous substance, an antioxidant, and a cleaning property enhancer.

[Production Method, Etc. Of Toner Particles]

Examples of the production method of toner particles include a method in which the toner raw material containing the binder resin and the colorant is melt kneaded and then pulverized; a method in which an aqueous binder resin dispersion and an aqueous colorant dispersion are mixed, thereby unifying the binder resin particles and the colorant particles; and a method in which the aqueous binder resin dispersion and the colorant are subjected to high-speed agitation. From the viewpoint of developing property and fixing property, a method in which the toner raw material is melt kneaded and then pulverized is preferred. Details thereof are described in Step 1 as mentioned later.

The content of the toner particles is preferably 10 parts by mass or more, more preferably 20 parts by mass or more, and still more preferably 30 parts by mass or more from the viewpoint of high-speed printing property, and it is preferably 100 parts by mass or less, more preferably 80 parts by mass or less, still more preferably 70 parts by mass or less, and yet still more preferably 60 parts by mass or less from the viewpoint of dispersion stability, based on 100 parts by mass of the insulating liquid.

### <Insulating Liquid>

The insulating liquid means a liquid through which electricity is hard to pass.

A conductivity of the insulating liquid is preferably 1.0×10⁻¹¹ S/m or less, and more preferably 5.0×10⁻¹² S/m or less, and it is preferably 1.0×10⁻¹³ S/m or more.

Examples of the insulating liquid include an aliphatic hydrocarbon, an alicyclic hydrocarbon, an aromatic hydrocarbon, a halogenated hydrocarbon, and a polysiloxane. Of these, an aliphatic hydrocarbon and an alicyclic hydrocarbon are preferred, and an aliphatic hydrocarbon is more preferred.

Examples of the aliphatic hydrocarbon include a normal paraffin and an isoparaffin. Of these, an isoparaffin is preferred.

Examples of a commercially available product of the insulating liquid include “ISOPAR G”, “ISOPAR H”, “ISOPAR, L”, and “ISOPAR K” (all of which are available from Exxon Mobil Corporation); “SHELLSOL 71” (available from Showa Shell Sekiyu K.K.); “IP SOLVENT 1620” and “IP SOLVENT 2080” (all of which are available from Idemitsu Kosan Co., Ltd.); “MORESCO WHITE P-55” and “MORESCO WHITE P-70” (all of which are available from Matsumura Oil Co., Ltd.); and “COSMO WHITE P-60” and “COSMO WHITE P-70” (all of which are available from Cosmo Oil Lubricants Co., Ltd.).

A viscosity at 25° C. of the insulating liquid is preferably 100 mPa·s or less, more preferably 50 mPa·s or less, still more preferably 20 mPa·s, yet still more preferably 10 mPa·s or less, and even yet still more preferably 5 mPa·s or less, and it is preferably 0.01 mPa·s or more, and more preferably 0.1 mPa·s or more.

<Physical Properties, Etc. Of Liquid Developer>

A solid content concentration of the liquid developer is preferably 10% by mass or more, more preferably 15% by mass or more, and still more preferably 20% by mass or more from the viewpoint of improvement in image density, and it is preferably 50% by mass or less, more preferably 45% by mass or less, and still more preferably 40% by mass or less from the viewpoint of improvement in dispersion stability of the toner particles and improvement in storage stability.

A volume median diameter (D₅₀) of the toner particles in the liquid developer is preferably 0.5 μm or more, more preferably 1 μm or more, and still more preferably 1.5 μm or more from the viewpoint of reduction in viscosity of the liquid developer, and it is preferably 10 μm or less, more preferably 6 μm or less, still more preferably 5 μm or less, and yet still more preferably 4 μm or less from the viewpoint of improvement in image quality of the liquid developer.

A viscosity of the liquid developer at a solid content concentration of 25% by mass and at a temperature of 25° C. is preferably 1 mPa·s or more, more preferably 2 mPa·s or more, yet still more preferably 3 mPa·s or more, and even yet still more preferably 5 mPa·s or more from the viewpoint of improvement of fixing property of the liquid developer, and it is preferably 50 mPa·s or less, more preferably 40 mPa·s or less, still more preferably 30 mPa·s or less, and yet still more preferably 20 mPa·s or less from the viewpoint of improvement in dispersion stability of the liquid developer and aggregation prevention.

A resistance of the liquid developer at a solid content concentration of 25% by mass and at a temperature of 25° C. is preferably 5.0×10⁹ Ω·m or more, more preferably 1.0×10¹⁰ Ω·m or more, and still more preferably 5.0×10¹⁰ Ω·m or more, and it is preferably 1.0×10¹³ Ω·m or less.

The aforementioned viscosity and resistance are those as measured by the methods described in the section of Examples.

### <Dispersant>

The liquid developer may contain a dispersant so long as the effects of the present invention are not impaired. The dispersant is used in order to stably disperse the toner particles in the insulating liquid.

Examples of the dispersant include a condensate between a polyalkyleneimine and a carboxylic acid (hereinafter also referred to simply as “condensate”), an alkyl methacrylate/amino group-containing methacrylate copolymer, and an α-olefin/vinylpyrrolidone copolymer (“ANTARON V-216” (available from Ashland Japan Ltd.) as a commercially available product). Of these, a condensate between a polyalkyleneimine and a carboxylic acid is preferred.

Examples of the polyalkyleneimine include polyethyleneimine, polypropyleneimine, and polybutyleneimine. Of these, polyethyleneimine is preferred.

An addition molar number of ethyleneimine of polyethyleneimine is preferably 10 or more, and more preferably 100 or more, and it is preferably 1,000 or less, and more preferably 500 or less.

Meanwhile, for example, from the viewpoint of improvement in dispersion stability of the toner particles and improvement in storage stability, examples of the carboxylic acid include an aliphatic carboxylic acid having 10 or more and 30 or less carbon atoms.

The carbon number of the aliphatic carboxylic acid is preferably 10 or more, more preferably 12 or more, and still more preferably 16 or more, and it is preferably 30 or less, more preferably 24 or less, and still more preferably 22 or less.

Although the aliphatic carboxylic acid may be either linear or branched, a linear carboxylic acid is more preferred.

Examples of the aliphatic carboxylic acid include lauric acid, myristic acid, palmitic acid, stearic acid, oleic acid, linoleic acid, and linolenic acid.

The carboxylic acid may also be a hydroxycarboxylic acid having a hydroxy group as a substituent. Examples of the hydroxycarboxylic acid include mevalonic acid, ricinoleic acid, and 12-hydroxystearic acid. The hydroxycarboxylic acid may also be a condensate thereof.

A weight average molecular weight of the condensate is preferably 2,000 or more, more preferably 4,000 or more, and still more preferably 8,000 or more, and it is preferably 50,000 or less, more preferably 40,000 or less, and still more preferably 30,000 or less.

Examples of a commercially available product of the condensate include “11200” and “13940” of “SOLSPERSE” Series (all of which are available from Nippon Lubrizol Corporation).

In the present invention, even when the content of the dispersant is 0% by mass in the liquid developer, namely even when the dispersant is absent, the liquid developer is able to disperse the toner particles. But, the dispersant may be used so long as the effects of the present invention are not impaired.

When the dispersant is added in order to improve the dispersion stability, the resistance of the liquid developer becomes low, and the development characteristics tend to be lowered. Therefore, in the first embodiment of the present invention, it is preferred that the dispersant is not used. In the first embodiment of the present invention, the content of the dispersant in the liquid developer is preferably 1% by mass or less, more preferably 0.5% by mass or less, and still more preferably 0.2% by mass or less.

In the second embodiment of the present invention, the content of the dispersant is preferably 20 parts by mass or less, more preferably 15 parts by mass or less, still more preferably 10 parts by mass or less, and yet still more preferably 5 parts by mass or less, and it is 0 part by mass or more, preferably 0.5 parts by mass or more, more preferably 1 part by mass or more, and still more preferably 2 parts by mass or more, based on 100 parts by mass of the toner particles.

### [Production Method of Liquid Developer]

Preferably, a method for producing a liquid developer includes:

Step 1: a step of melt kneading the binder resin including a polyester resin A and a colorant, and further, in the second embodiment of the present invention, an acid-modified product A of a polymer of an α-olefin having 3 or more and 18 or less carbon atoms and then pulverizing, to obtain toner particles;

Step 2: a step of dispersing the toner particles obtained in the step 1 in an insulating liquid, to obtain a dispersion; and

Step 3: a step of wet pulverizing the dispersion obtained in the step 2, to obtain a liquid developer.

### [Step 1]

In the step 1, it is preferred that a toner raw material containing the binder resin and the colorant, and further, in the second embodiment of the present invention, the acid-modified product A of a polymer of an α-olefin having 3 or more and 18 or less carbon atoms, as well as optionally used additives, etc. is previously mixed in a mixing machine, such as a Henschel mixer, a super mixer, and a ball mill, and then fed into a kneading machine.

From the viewpoint of improvement in dispersibility of the colorant in the binder resin, a Henschel mixer is preferred as the mixing machine

Mixing with a Henschel mixer is performed while regulating a peripheral speed of agitation and an agitation time. From the viewpoint of improvement in dispersibility of the colorant, the peripheral speed is preferably 10 m/sec or more and 30 m/sec or less. In addition, from the viewpoint of improvement in dispersibility of the colorant, the agitation time is preferably 1 minute or more and 10 minutes or less.

Subsequently, melt kneading of the toner raw material can be performed using a kneading machine, such as a closed kneader, a single-screw or twin-screw kneading machine, and a continuous open roll type kneading machine. In the present invention, from the viewpoint of improvement in dispersibility of the colorant and the viewpoint of improvement in yield of the toner particles after pulverization, an open roll type kneading machine is preferred.

Subsequently, the melt-kneaded product is cooled to an extent that pulverization is possibly performed and then passed through a pulverization step and optionally a classification step, whereby the toner particles can be obtained.

The pulverization step may be performed divided into multistage operations. For example, the melt-kneaded product may be coarsely pulverized in a size of about 1 to 5 mm and then finely pulverized. In addition, in order to improve productivity during the pulverization step, the melt-kneaded product may be mixed with inorganic fine particles of hydrophobic silica, etc. and then pulverized.

Examples of a pulverizer which is suitably used for coarse pulverization include an atomizer, a rotoplex, and a hammer mill. In addition, examples of a pulverizer which is suitably used for fine pulverization include a fluidized bed type jet mill, a pneumatic jet mill, and a mechanical mill.

Examples of a classifier which is used for the classification step include a pneumatic classifier, an inertial classifier, and a screen-type classifier. If desired, the pulverization step and the classification step may be repeatedly performed.

From the viewpoint of improvement in productivity of the step 2 as mentioned later, the volume median diameter (1150) of the toner particles obtained in the step 1 is preferably 3 μm or more, and more preferably 4 μm or more, and it is preferably 15 μm or less, and more preferably 12 μm or less.

### [Step 2]

In the step 2, the toner particles obtained in the step 1 are dispersed in an insulating liquid, to obtain a dispersion.

Examples of the method of dispersing the toner particles in the insulating liquid include a method of performing agitation with an agitation mixing apparatus. Owing to the agitation mixing apparatus, the toner particles are preliminarily dispersed, whereby the toner particle dispersion can be obtained, and the productivity of the liquid developer by the subsequent wet pulverization is improved.

Examples of the agitation mixing apparatus include a high-speed agitation mixing apparatus.

Examples of a commercially available product of the agitation mixing apparatus include “DESPA” (available from Asada Tekko Co., Ltd.); “T.K. HOMO MIXER”, “T.K. HOMO DISPER”, and “T.K. ROBOMIX” (all of which are available from PRIMIX Corporation); “CLEARMIX” (available from M Technique Co., Ltd.); and “KADY Mill” (available from KADY International).

From the viewpoint of improvement in image density, a solid content concentration of the toner particle dispersion is preferably 5% by mass or more, more preferably 10% by mass or more, and still more preferably 20% by mass or more, and it is preferably 50% by mass or less, more preferably 40% by mass or less, and still more preferably 30% by mass or less.

### [Step 3]

In the step 3, the dispersion obtained in the step 2 is subjected to wet pulverization, to obtain a liquid developer.

The wet pulverization is a method of mechanically pulverizing the toner particles dispersed in the insulting liquid in a state that they are dispersed in the insulating liquid.

As an apparatus which is used for the wet pulverization, a generally used agitation mixing apparatus, for example, an anchor blade, can be used.

Examples of the agitation mixing apparatus include high-speed agitation mixing apparatuses, such as “DESPA” (available from Asada Tekko Co., Ltd.) and “T.K. HOMO MIXER” (available from PRIMIX Corporation); pulverizers, such as a roll mill and a bead mill; and kneading machines, such as a kneader and an extruder. These apparatuses may be used either alone or in combination of two or more thereof.

Of these, a bead mill is preferred.

According to the bead mill, by controlling a particle diameter of media to be used and a packing ratio thereof, a peripheral speed of a rotator, a residence time, and so on, toner particles having desired particle diameter and particle diameter distribution can be obtained.

### [Printing Method]

The foregoing liquid developer is housed in a liquid developer cartridge, from which an image can be formed by means of electrophotographic image formation with a liquid developer.

The liquid developer can be used for printing on a PP film. That is, the liquid developer is suitable for use as a liquid developer for propylene film printing with a liquid developer. In particular, the liquid developer of the second embodiment of the present invention is excellent in fixing property on a polypropylene film, and therefore, it can be suitably used for printing on a PP film.

The production method of a printed matter of the present invention is a method for producing a printed matter including a step of printing on a recording medium with a liquid developer, wherein the liquid developer is the liquid developer of the present invention (preferably the liquid developer of the second embodiment of the present invention), and the recording medium is a polypropylene film.

Printing on the PP film with the liquid developer is performed by using a usual electrophotographic image forming apparatus system.

Examples of the PP film include an untreated stretched PP film, a corona-treated PP film, a chemical-treated PP film, a plasma-treated PP film, and a stretched film of a composite resin of PP and any other resin and additive. From the viewpoint of cost, an untreated stretched PP film and a corona-treated PP film are preferred.

From the viewpoint of effectively achieving an interaction between the toner particles and the PP film, as for a fixing temperature of the liquid developer, it is preferred to set the fixing temperature to a melting point of the acid-modified product A of the polymer of an α-olefin having 3 or more and 18 or less carbon atoms (preferably the acid-modified polyester polymer) or higher.

The fixing temperature in electrophotography is preferably 180° C. or lower, more preferably 160° C. or lower, and still more preferably 140° C. or lower from the viewpoint of heat resistance of the PP film, and it is preferably 70° C. or higher, more preferably 80° C. or higher, and still more preferably 90° C. or higher from the viewpoint of fixing property.

### EXAMPLES

The present invention is hereunder specifically described by reference to Examples, but it should be construed that the present invention is by no means limited by these Examples. Physical properties of the resins and so on were measured by the following methods.

### [Measurement Methods]

### [Weight Average Molecular Weight (Mw) of Resin]

The weight average molecular weight is determined by the following method according to the gel permeation chromatography (GPC).

### (1) Preparation of Sample Solution

A sample is dissolved in tetrahydrofuran at 40° C. such that its concentration is 0.5 g/100 mL. Subsequently, this solution is filtered with a polytetrafluoroethylene (PTFE)-made membrane filter, “DISMIC-25JP” having a pore diameter of 0.20 μm (available from Toyo Roshi Kaisha, Ltd.) to remove an insoluble component, thereby preparing a sample solution.

### (2) Measurement of Molecular Weight

Using the following measuring apparatus and analytical column, tetrahydrofuran as an eluent is allowed to flow at a flow rate of 1 mL per minute, thereby stabilizing the column in a thermostat at 40° C. 100 μL of the sample solution is injected thereinto, and the measurement is performed. The molecular weight of the sample is calculated on the basis of a previously prepared calibration curve. For the calibration curve at this time, one prepared from several kinds of monodisperse polystyrenes (A-500 (5.0×10²), A-1000 (1.01×10³), A-2500 (2.63×10³), A-5000 (5.97×10³), F-1 (1.02×10⁴), F-2 (1.81×10⁴), F-4 (3.97×10⁴), F-10 (9.64×10⁴), F-20 (1.90×10⁵), F-40 (4.27×10⁵), F-80 (7.06×10⁵), and F-128 (1/09×10⁶), all of which are available from Tosoh Corporation) as standard samples is used. The numerical values within the parentheses each express the molecular weight.

Measuring apparatus: HLC-8220GPC (available from Tosoh Corporation)

Analytical column: TSKgel GMHXL+TSKgel G3000HXL (available from Tosoh Corporation)

### [Softening Point of Resin]

Using a flow tester, “CFT-500D” (available from Shimadzu Corporation), 1 g of a sample is extruded from a nozzle having a diameter of 1 mm and a length of 1 mm owing to a plunger by applying a load of 1.96 MPa while heating at a temperature rise rate of 6° C./min. A downward movement of the plunger of the flow test is plotted against the temperature, and a temperature at which a half of the sample flows out is defined as the softening point.

### [Glass Transition Temperature (Tg) of Resin]

Using a differential scanning calorimeter, “DSC 210” (available from Seiko Instruments, Inc.), 0.01 to 0.02 g of a sample is weighed on an aluminum pan, and the temperature is raised to 200° C. and then dropped from that temperature to 0° C. at a temperature drop rate of 10° C./min. Subsequently, the sample is subjected to temperature elevation at a temperature rise rate of 10° C./min, to measure an endothermic peak. A temperature of an intersection of the extension of a baseline of equal to or lower than a temperature of a maximum endothermic peak and a tangential line showing a maximum inclination between a kick-off of the peak and a top of the peak is defined as the glass transition temperature.

### [Acid Value and Hydroxyl Value of Resin]

The measurement is performed by the method of JIS K0070:1992. However, only a measurement solvent is changed from a mixed solvent of ethanol and ether as prescribed in JIS K0070:1992 to a mixed solvent of acetone and toluene (acetone/toluene=1/1 (volume ratio)).

[Volume Median Diameter (D₅₀) of Toner Particles Before Mixing with Insulating Liquid]

Measuring apparatus: Coulter Multisizer II (available from Beckman Coulter, Inc.)

Aperture diameter: 100 μm

Analyzing software: Coulter Multisizer AccuComp Ver. 1.19 (available from Beckman Coulter, Inc.)

Electrolytic solution: “ISOTONE II” (available from Beckman Coulter, Inc.)

Dispersion: One prepared by dissolving “EMULGEN 109P” (available from Kao Corporation, polyoxyethylene lauryl ether, HLB (Griffin): 13.6) at a concentration of 5% by mass in an electrolytic solution

Dispersion condition: 10 mg of a measurement sample is added to 5 mL of the aforementioned dispersion, and the mixture is dispersed for 1 minute with an ultrasonic disperser, “US-1” (available from SND Co., Ltd., output: 80 W). Thereafter, 25 mL of the aforementioned electrolytic solution is added and further dispersed with an ultrasonic disperser for 1 minute, to prepare a sample dispersion.

Measurement condition: To 100 mL of the aforementioned electrolytic solution, the aforementioned sample dispersion is added at a concentration such that the particle diameter of the 30,000 particles can be measured for 20 seconds, to measure the 30,000 particles, and the volume median diameter (D50) is obtained from a particle size distribution thereof.

### [Conductivity of Insulating Liquid]

25 g of a sample is charged in a 40-mL capacity glass-made sample tube, “SCREW No. 7” (available from Maruemu Corporation), electrodes are dipped in the insulating liquid by using a non-aqueous conductivity meter, “DT-700” (available from Dispersion Technology Inc.), and the measurement is performed 20 times at 25° C. to calculate an average value, thereby measuring the conductivity. It is meant that the smaller the numerical value, the higher the resistance.

### [Viscosity at 25° C. of Insulating Liquid]

6 to 7 mL of a measuring liquid is charged in a 10-mL capacity screwed tube; using a rotational vibration type viscometer, “VISCOMETER VM-10A-L” (available from Sekonic Corporation, detection terminal: made of titanium, φ8 mm), the screwed tube is fixed at a position where the liquid level reaches 15 mm above the tip part of the detection terminal; and the viscosity is measured at 25° C.

### [Solid Content Concentrations of Toner Particle Dispersion and Liquid Developer]

10 parts by mass of a sample is diluted with 90 parts by mass of hexane and rotated with a centrifuge, “3-30KS” (available from Sigma Laborzentrifugen GmbH) at a rotation number of 25,000 r/min for 20 minutes. After allowing to stand still, a supernatant is removed by means of decantation, and the residue is diluted with 90 parts by mass of hexane and then again centrifuged under the same condition. A supernatant is removed by means of decantation, a lower layer is then dried with a vacuum dryer at 0.5 kPa and 40° C. for 8 hours, and the solid content concentration is calculated according to the following expression.

Solid content concentration (% by mass)=[(Mass of residue after drying)/(Mass of 10 parts by mass portion of sample)]×100

### [Volume Median Diameter (D₅₀) of Toner Particles in Liquid Developer]

Using a laser diffraction/scattering type particle size analyzer, “MASTERMIZER 2000” (available from Malvern Panalytical Ltd.), ISOPAR L (isoparaffin, available from Exxon Mobil Corporation, viscosity at 25° C.: 1 mPa·s) is added in a measurement cell, and the volume median diameter (D₅₀) is measured at a concentration at which the scattering intensity is 5 to 15% under a condition at a particle refractive index of 1.58 (imaginary part: 0.1) and a dispersion medium refractive index of 1.42.

### [Viscosity of Liquid Developer at Solid Content Concentration of 25% by Mass and at Temperature of 25° C.]

6 to 7 mL of a liquid developer having a solid content concentration regulated to 25% by mass is charged in a 10-mL capacity screwed tube; using a rotational vibration type viscometer, “VISCOMETER VM-10A-L” (available from Sekonic Corporation, detection terminal: made of titanium, φ8 mm), the screwed tube is fixed at a position where the liquid level reaches 15 mm above the tip part of the detection terminal; and the viscosity is measured at 25° C.

### [Resistance of Liquid Developer at Solid Content Concentration of 25% by Mass and at Temperature of 25° C.]

25 g of a liquid developer having a solid content concentration regulated to 25% by mass is charged in a 40-mL capacity glass-made sample tube, “SCREW No. 7” (available from Maruemu Corporation), electrodes are dipped in the insulating liquid by using a non-aqueous conductivity meter, “DT-700” (available from Dispersion Technology Inc.), the measurement is performed 20 times at 25° C. to calculate an average value, thereby measuring the conductivity, and a reciprocal thereof is defined as a resistance. It is meant that the higher the numerical value, the higher the resistance, and the more favorable the printing quality.

### [Fixing Property on PP Film]

On a corona-treated surface or untreated surface of a PP film, “FOR25” shown below (available from Futamura Chemical Co., Ltd.) as shown below, a liquid developer was dropped, and a thin film was prepared using a wire bar such that the mass after drying was 1.2 g/m². Thereafter, the resultant was allowed to stand in a thermostat at 120° C. for 6 minutes, thereby achieving fixing.

A mending tape, “Scotch Mending Tape 810” (available from 3M Japan Limited, width: 18 mm) was stuck onto the resulting fixed image, a pressure was applied onto the tape by using a roller so as to apply a load of 500 g, and the tape was then released. An image density before and after release of the tape was measured with a colorimeter, “GretagMacbeth Spectroeye” (available from Gretag Imaging AG). Three points of the image printed portion were measured, and an average value thereof was calculated as an image density. A fixing rate (%) was calculated from a value of [{(image density after release)/(image density before release)}×100]. It is meant that the larger the value of the fixing rate, the more excellent the fixing property.

### Production of Branched Alkenyl Succinic Anhydride

### Production Example AS1

### (Production of Alkene Mixture (a))

Using a propylene tetramer, “Light Tetramer” (available from Nippon Oil Corporation), fractional distillation was performed under a heating condition of 183 to 208° C., to obtain an alkylene mixture (a). The resulting alkylene compound (a) had 40 peaks in the gas chromatography mass spectroscopy as mentioned later. The distribution of the alkylene mixture was measured according to the mass analysis gas chromatography of the alkylene compound A as described in JP 2014-013384 A and found to be C₉H₁₈: 0.5% by mass, C₁₀H₂₀: 4% by mass, C₁₁H₂₂: 20% by mass, C₁₂H₂₄: 66% by mass, C₁₃H₂₆: 9% by mass, and C₁₄H₂₈: 0.5% by mass (number of peaks corresponding to the alkenes having 9 to 14 carbon atoms: 6).

### (Production of Branched Alkenyl Succinic Anhydride)

In a 1-liter autoclave, available from Nitto Kouatsu Co., Ltd.), 542.4 g of the alkene mixture (a), 157.2 g of maleic anhydride, 0.4 g of an antioxidant “Chelex-0” (triisooctyl phosphite, available from SC Organic Chemical Co., Ltd.), and 0.1 g of butyl hydroquinone as a polymerization inhibitor were charged, and displacement with pressurized nitrogen (0.2 MPaG) was repeated three times. After commencement of stirring at 60° C., the temperature was raised to 230° C. over 1 hour, and the reaction was performed for 6 hours. A pressure at the time of reaching the reaction temperature was 0.3 MPaG. After completion of the reaction, the reaction product was cooled to 80° C. and returned to atmospheric pressure (101.3 kPa), followed by transferring into a 1-liter four-necked flask. The temperatures was raised to 180° C. while stirring, and the residual alkylene compound was distilled off at 1.3 kPa for 1 hour. Subsequently, the residue was cooled to room temperature (25° C.) and returned to atmospheric pressure (101.3 kPa), thereby obtaining 406.1 g of the target alkenyl succinic anhydride. An average molecular weight of the alkenyl succinic anhydride determined from the acid value was 268.

### First Embodiment of Present Invention

### Production of Resin

### Production Examples A101 to A105 (Production of Resins A-101 to A-105)

In a 10-liter capacity four-necked flask equipped with a nitrogen inlet tube, a dewatering tube, a stirrer, and a thermocouple, raw material monomers shown in Table 1, the compound A, tin(II) di(2-ethylhexanoate) as an esterification catalyst, and gallic acid as an esterification promoter were charged, and the temperature was raised to 230° C., to undergo the reaction. After 24 hours, the reaction was terminated at the point of time when the acid value reached 7 mgKOH/g or less. There were thus obtained resins (resins A-101 to A-105) having physical properties shown in Table 1.

### Production Examples A151 to A153 (Production of Resin A-151 to A-153)

In a 10-liter capacity four-necked flask equipped with a nitrogen inlet tube, a dewatering tube, a stirrer, and a thermocouple, raw material monomers shown in Table 1, tin(II) di(2-ethylhexanoate) as an esterification catalyst, and gallic acid as an esterification promoter were charged, and the temperature was raised to 230° C., to undergo the reaction. After 24 hours, the reaction was terminated at the point of time when the acid value reached 7 mgKOH/g or less. There were thus obtained resins (resins A-151 to A-153) having physical properties shown in Table 1.

TABLE 1

| Production Example | | | Production Example A101 | | Production Example A102 | | Production Example A103 | | Production Example A104 | |
|---|---|---|---|---|---|---|---|---|---|---|
| Resin | | | A-101 | | A-102 | | A-103 | | A-104 | |
| Raw material | | | Charged | Molar | Charged | Molar | Charged | Molar | Charged | Molar |
| monomers of | | | amount (g) | ratio *1 | amount (g) | ratio *1 | amount (g) | ratio *1 | amount (g) | ratio *1 |
| polyester resin | Alcohol | BPA-PO *4 | 2916 | 100 | 2916 | 100 | 2870 | 100 | 2916 | 100 |
| | component | | | | | | | | | |
| | Carboxylic acid | Terephthalic acid | 1134 | 82 | 1134 | 82 | 1130 | 82 | 1134 | 82 |
| | component | | | | | | | | | |
| | | | Charged | Mass % | Charged | Mass % | Charged | Mass % | Charged | Mass % |
| | | | amount (g) | *2 | amount (g) | *2 | amount (g) | *2 | amount (g) | *2 |
| | Compound A | Ma-PP (Mn: 1000) | 750 | 15(8) | — | — | — | — | — | — |
| | | Ma-PP (Mn: 2500) | — | — | 750 | 15(3.2) | — | — | — | — |
| | | Ma-PP/Hex (Mn: 4000) | — | — | — | — | 1000 | 20(2.7) | — | — |
| | | Ma-PIB (Mn: 1000) | — | — | — | — | — | — | 750 | 15(8) |
| | | Branched alkenyl | — | — | — | — | — | — | — | — |
| | | succinic anhydride | | | | | | | | |
| | | Linear alkenyl | — | — | — | — | — | — | — | — |
| | | succinic anhydride | | | | | | | | |

| Acid value of | 100 | 35 | 25 | 100 |
|---|---|---|---|---|
| compound A | | | | |
| (mgKOH/g) | | | | |
| Number average | 1000 | 2500 | 4000 | 1000 |
| molecular weight (Mn) | | | | |
| of compound A | | | | |
| Modification moiety | Terminal | Terminal | Terminal | Terminal |
| Melting point of | 90 | 130 | 80 | −20 |
| compound A (° C.) | | | | |

| | | | | | | | | | |
|---|---|---|---|---|---|---|---|---|---|
| | | Charged | Parts by | Charged | Parts by | Charged | Parts by | Charged | Parts by |
| | | amount (g) | mass *3 | amount (g) | mass *3 | amount (g) | mass *3 | amount (g) | mass *3 |
| Esterification | Tin(II) di(2-ethylhexanoate) | 24 | 0.6 | 24 | 0.6 | 24 | 0.6 | 24 | 0.6 |
| catalyst | | | | | | | | | |
| Promoter | Gallic acid | 2 | 0.05 | 2 | 0.05 | 2 | 0.05 | 2 | 0.05 |

| | | | | | |
|---|---|---|---|---|---|
| Physical | Acid value (mgKOH/g) | 5 | 5 | 6 | 7 |
| properties | Glass transition temperature (° C.) | 55 | 57 | 61 | 50 |
| | Softening point (° C.) | 105 | 107 | 112 | 97 |

*1: Molar number when the whole amount of the alcohol component is defined as 100 mol
*2: Mass ratio (% by mass) relative to the total amount of the alcohol component, the carboxylic acid component, and the compound A
The numerical value within the parenthesis expresses the molar number when the whole amount of the alcohol component is defined as 100 mol.
*3: Mass ratio (parts by mass) relative to the total amount of the alcohol component and the carboxylic acid component
*4: BPA-PO: Propylene oxide (2.2) adduct of 2,2-bis(4-hydroxyphenyl)propane
Ma-PP (Mn 1000): Polypropylene terminally modified with maleic anhydride at one terminal, “X-10065” (available from Baker Hughes Incorporated, number average molecular weight Mn 1000, melting point 90° C.)
Ma-PP (Mn 2500): Polypropylene terminally modified with maleic anhydride at one terminal, “X-10088” (available from Baker Hughes Incorporated, number-average molecular weight Mn 2500, melting point 130° C.)
Ma-PP/Hex (Mn 4000): Propylene/hexene copolymer terminally modified with maleic anhydride at one terminal, “X-10052” (available from Baker Hughes Incorporated, number-average molecular
weight Mn 4000, melting point 80° C.)
Ma-PIB: Polyisobutene terminally modified with maleic anhydride at one terminal, “OLOA 15500” (available from Chevron Oronite SA, number average molecular weight Mn 1000)
Branched alkenyl succinic acid: Branched alkenyl succinic anhydride obtained in Production Example AS1
Linear alkenyl succinic acid: Dodecenylsuccinic anhydride available from Fujifilm Wako Pure Chemical Corporation, number average molecular weight Mn 268)

| Production Example | | | Production Example A105 | | Production Example A51 | | Production Example A152 | | Production Example A153 | |
|---|---|---|---|---|---|---|---|---|---|---|
| Resin | | | A-105 | | A-151 | | A-152 | | A-153 | |
| Raw material | | | Charged | Molar | Charged | Molar | Charged | Molar | Charged | Molar |
| monomers of | | | amount (g) | ratio *1 | amount (g) | ratio *1 | amount (g) | ratio *1 | amount (g) | ratio *1 |
| polyester resin | Alcohol | BPA-PO *4 | 3197 | 100 | 2968 | 100 | 3176 | 100 | 3176 | 100 |
| | component | | | | | | | | | |
| | Carboxylic acid | Terephthalic acid | 1243 | 85 | 1267 | 90 | 904 | 60 | 904 | 60 |
| | component | | | | | | | | | |
| | | | Charged | Mass % | Charged | Mass % | Charged | Mass % | Charged | Mass % |
| | | | amount (g) | *2 | amount (g) | *2 | amount (g) | *2 | amount (g) | *2 |
| | Compound A | Ma-PP (Mn: 1000) | 360 | 7.5(4) | — | — | — | — | — | — |
| | | Ma-PP (Mn: 2500) | — | — | — | — | — | — | — | — |
| | | Ma-PP/Hex (Mn: 4000) | — | — | — | — | — | — | — | — |
| | | Ma-PIB (Mn: 1000) | — | — | — | — | — | — | — | — |
| | | Branched alkenyl | — | — | — | — | 750 | 15(32.3) | — | — |
| | | succinic anhydride | | | | | | | | |
| | | Linear alkenyl | — | — | — | — | — | — | 750 | 15(32.3) |
| | | succinic anhydride | | | | | | | | |
| | | Acid value of | 100 | | — | | 438 | | 438 | |
| | | compound A | | | | | | | | |
| | | (mgKOH/g) | | | | | | | | |
| | | Number average | 1000 | | — | | Molecular weight | | Molecular weight | |
| | | molecular weight (Mn) | | | | | 266 | | 266 | |
| | | of compound A | | | | | | | | |
| | | Modification moiety | Terminal | | — | | Terminal | | Terminal | |
| | | Melting point of | 90 | | — | | −13 | | 45 | |
| | | compound A (° C.) | | | | | | | | |
| | | | Charged | Parts by | Charged | Parts by | Charged | Parts by | Charged | Parts by |
| | | | amount (g) | mass *3 | amount (g) | mass *3 | amount (g) | mass *3 | amount (g) | mass *3 |

| | | | | | | | | | |
|---|---|---|---|---|---|---|---|---|---|
| Esterification | Tin(II) di(2-ethylhexanoate) | 24 | 0.5 | 21 | 0.5 | 24 | 0.6 | 24 | 0.6 |
| catalyst | | | | | | | | | |
| Promoter | Gallic acid | 2 | 0.05 | 2 | 0.05 | 2 | 0.05 | 2 | 0.05 |

| | | | | | |
|---|---|---|---|---|---|
| Physical | Acid value (mgKOH/g) | 3 | 9 | 4 | 4 |
| properties | Glass transition temperature (° C.) | 59 | 68 | 54 | 39 |
| | Softening point (° C.) | 104 | 100 | 100 | 89 |

*1 Molar number when the whole amount of the alcohol component is defined as 100 mol
*2 Mass ratio 1% by mass) relative to the total amount of the alcohol component, the carboxylic acid component, and the compound A
The numerical value within the parenthesis expresses the molar number when the whole amount of the alcohol component is defined as 100 mol.
*3 Mass ratio (parts by mass) relative to the total amount of the alcohol component and the carboxylic acid component
*4 BPA-PO: Propylene oxide (2.2) adduct of 2,2-bis(4-hydroxyphenyl)propane
Ma-PP (Mn 1000): Polypropylene terminally modified with maleic anhydride at one terminal, “X-10065” (available from Baker Hughes Incorporated, number average molecular weight Mn 1000, melting point 90° C.)
Ma-PP (Mn 2500): Polypropylene terminally modified with maleic anhydride at one terminal, “X-10088” (available from Baker Hughes Incorporated, number-average molecular weight Mn 2500, melting point 130° C.)
Ma-PP/Hex (Mn 4000): Propylene/hexene copolymer terminally modified with maleic anhydride at one terminal, “X-10052” (available from Baker Hughes Incorporated, number-average molecular weight Mn 4000, melting point 80° C.)
Ma-PIB: Polyisobutene terminally modified with maleic anhydride at one terminal, “OLOA 15500” (available from Chevron Oronite SA, number average molecular weight Mn 1000)
Branched alkenyl succinic acid: Branched alkenyl succinic anhydride obtained in Production Example AS1
Linear alkenyl succinic acid: Dodecenylsuccinic anhydride (available from Fujifilm Wako Pure Chemical Corporation number average molecular weight Mn 268)

### Production of Toner

### Examples 101 to 105 and Comparative Examples 101, 103, and 104 (Liquid Developers 101 to 105, 151, 153, and 154)

Using a 20-liter capacity Henschel mixer, 100 parts by mass of a binder resin shown in Table 2 and 25 parts by mass of a colorant, “ECB-301” (phthalocyanine blue 15:3, available from Dainichiseika Color & Chemicals Mfg. Co., Ltd.) were previously stirred and mixed at a rotation number of 1,500 r/min (peripheral speed: 21.6 m/sec) for 3 minutes.

Thereafter, a continuous twin open roll type kneading machine, “Kneadex” (available from Nippon Coke & Engineering Co., Ltd., outer diameter of roll: 14 cm, effective length of roll: 55 cm) was used. The operating condition of the continuous twin open roll type kneading machine was as follows: a rotation number of high-rotation roll (front roll) of 75 r/min (peripheral speed: 32.4 m/min), a rotation number of low-rotation (back roll) of 35 r/min (peripheral speed: 15.0 m/min), and a gap between the rolls at an end of the kneaded product-feeding side of 0.1 mm. The temperatures of the heating medium and the cooling medium inside the rolls were as follows. The high-rotation roll had a temperature at the raw material-feeding side of 90° C.; a temperature at the kneaded product-discharging side of 85° C.; and the low-rotation roll had a temperature at the raw material-feeding side of 35° C., and a temperature at the kneaded product-discharging side of 35° C. In addition, the feeding rate of the raw material mixture to the kneading machine was 10 kg/h, and an average residence time in the kneading machine was about 3 minutes.

The resulting kneaded product was roll-cooled with a cooling roll, and the resultant was coarsely pulverized with a hammer mill to a size of about 1 mm. The resulting coarsely pulverized product was finely pulverized and classified with a pneumatic jet mill, “IDS” (available from Nippon Pneumatic Mfg. Co., Ltd.), to obtain toner particles having a volume median particle diameter (D₅₀) of 10 μm.

25 parts by mass of the resulting toner particles and 75 parts by mass of an insulating liquid, “ISOPAR L” (isoparaffin, available from Exxon Mobil Corporation, conductivity: 6.2×10⁻¹³ S/m, viscosity at 25° C.: 1 mPa·s) were charged in a 2-liter capacity polyethylene-made vessel. Using “T.K. ROBOMIX” (available from PRIMIX Corporation), the contents were stirred under ice-cooling at a rotation number of 7,000 r/min for 30 minutes, to obtain a toner particle dispersion having a solid content concentration of 25% by mass.

Subsequently, the resulting toner particle dispersion was subjected to wet pulverization for 4 hours with a 6 vessels-type sand mill, “TSG-6” (available from AIMEX CO., LTD.) at a rotational number of 1,300 r/min (peripheral speed: 4.8 m/sec) using zirconia beads having a diameter of 0.8 mm at a volume packing ratio of 60% by volume. The beads were removed by means of filtration, to obtain liquid developers 101 to 105, 151, 153, and 154.

### Comparative Example 102 (Liquid Developer 152)

25 parts by mass of toner particles obtained in the same manner as in Comparative Example 101, 1.0 part by mass of a dispersant, “SOLSPERSE 11200” (available from Nippon Lubrizol Corporation), and 74 parts by mass of an insulating liquid, “ISOPAR L” (isoparaffin, available from Exxon Mobil Corporation, conductivity: 6.2×10⁻¹³ S/m, viscosity at 25° C.: 1 mPa·s) were charged in a 2-liter capacity polyethylene-made vessel. Using “T.K. ROBOMIX” (available from PRIMIX Corporation), the contents were stirred under ice-cooling at a rotation number of 7,000 r/min for 30 minutes, to obtain a toner particle dispersion having a solid content concentration of 25% by mass.

Subsequently, the resulting toner particle dispersion was subjected to wet pulverization for 4 hours with a 6 vessels-type sand mill, “TSG-6” (available from AIMEX CO., LTD.) at a rotational number of 1,300 r/min (peripheral speed: 4.8 m/sec) using zirconia beads having a diameter of 0.8 mm at a volume packing ratio of 60% by volume. The beads were removed by means of filtration, to obtain a liquid developers 152.

With respect to the liquid developers obtained in the Examples and Comparative Examples, the physical properties were measured by the aforementioned methods. The results are shown in Table 2.

TABLE 2

| | | Composition of liquid developer | | | | | | | | |
|---|---|---|---|---|---|---|---|---|---|---|
| | | Toner particle | | | | | | Physical properties of liquid | | |
| | | Binder resin | | | Total | | Insulating | developer | | |
| | Liquid | | Amount | Colorant | amount | Dispersant | liquid | | Viscosity | Resistance |
| | developer | Resin | (parts by | (parts by | (parts by | (parts by | (parts by | D₅₀ | *1 | *1 |
| | No. | No. | mass) | mass) | mass) | mass) | mass) | (μm) | (mPa · s) | (Ω · m) |
| Example 101 | 101 | A-101 | 20 | 5 | 25 | 0 | 75 | 1.9 | 7 | 1.1 × 10¹¹ |
| Example 102 | 102 | A-102 | 20 | 5 | 25 | 0 | 75 | 2.2 | 12 | 1.7 × 10¹¹ |
| Example 103 | 103 | A-103 | 20 | 5 | 25 | 0 | 75 | 2.7 | 5 | 5.3 × 10¹⁰ |
| Example 104 | 104 | A-104 | 20 | 5 | 25 | 0 | 75 | 2.6 | 27 | 4.8 × 10¹⁰ |
| Example 105 | 105 | A-105 | 20 | 5 | 25 | 0 | 75 | 3.4 | 16 | 8.7 × 10¹⁰ |
| Comparative | 151 | A-151 | 20 | 5 | 25 | 0 | 75 | 18.2 | 78 | 8.9 × 10¹⁰ |
| Example 101 | | | | | | | | | | |
| Comparative | 152 | A-151 | 20 | 5 | 25 | 1 | 74 | 2.6 | 8 | 1.1 × 10⁹ |
| Example 102 | | | | | | | | | | |
| Comparative | 153 | A-152 | 20 | 5 | 25 | 0 | 75 | 6.4 | 49 | 2.9 × 10¹⁰ |
| Example 103 | | | | | | | | | | |
| Comparative | 154 | A-153 | 20 | 5 | 25 | 0 | 75 | 8.4 | 32 | 6.8 × 10¹⁰ |
| Example 104 | | | | | | | | | | |

*1: Value at a solid content concentration of 25% by mass and at a temperature of 25° C.

With respect to the first embodiment of the present invention, it is noted from the foregoing results that the liquid developers of the Examples have a small particle size without adding the dispersant and have a low viscosity, and exhibit a high resistance value.

On the other hand, the liquid developer of Comparative Example 101 is not able to micronize the toner particles because the polyester resin does not have self-dispersibility, and has a high viscosity. Even in the polyester resin not having self-dispersibility as in the liquid developer of Comparative Example 102, when the dispersant is added, micronization can be achieved, but the resistance value is lowered. The liquid developers of Comparative Examples 103 and 104 are constituted of the polyester resin having dodecenylsuccinic anhydride composited therewith, and therefore, they are low in the self-clispersibility and is not able to be micronized.

### Second Embodiment of Present Invention

### Production of Resin

### Production Examples A201 to A202 (Production of Resins A-201 to A-202)

In a 10-liter capacity four-necked flask equipped with a nitrogen inlet tube, a dewatering tube, a stirrer, and a thermocouple, raw material monomers shown in Table 3, tin(II) di(2-ethylhexanoate) as an esterification catalyst, and gallic acid as an esterification promoter were charged, and the temperature was raised to 230° C., to undergo the reaction for 12 hours. Thereafter, the pressure was further reduced to 8.3 kPa, to undergo the reaction for 1 hour. There were thus obtained resins A-201 to A-202 having physical properties shown in Table 3.

### Production Example A203 (Resin A-203)

In a 10-liter capacity four-necked flask equipped with a nitrogen inlet tube, a dewatering tube, a stirrer, and a thermocouple, raw material monomers of a polyester resin shown in Table 3, tin(II) di(2-ethylhexanoate) as an esterification catalyst, and gallic acid as an esterification promoter were charged, and the temperature was raised to 230° C., to undergo the reaction for 8 hours. Thereafter, the temperature was dropped to 170° C., raw material monomers of a vinyl resin shown in Table 3, a bireactive monomer, and a polymerization initiator were dropped from a dropping funnel over 1 hour. The addition polymerization reaction was matured for 1 hour while maintaining at 170° C., and the temperature was then raised to 210° C. The removal of the raw material monomers of the styrene resin and the reaction between the bireactive monomer and the polyester moiety were performed at 8.3 kPa for 1 hour, to obtain a resin A-203 having physical properties shown in Table 3.

TABLE 3

| | | | Production | | Production | | Production | |
|---|---|---|---|---|---|---|---|---|
| Production Example | | | Example A201 | | Example A202 | | Example A203 | |
| Resin | | | A-201 | | A-202 | | A-203 | |
| Raw material | | | Charged | Molar | Charged | Molar | Charged | Molar |
| monomer (P) of | | | amount (g) | ratio *2 | amount (g) | ratio *2 | amount (g) | ratio *2 |
| polyester resin | Alcohol | BPA-PO *1 | 2916 | 100 | 2747 | 90 | 2288 | 100 |
| segment | component | 1,2-Propanediol | — | — | 66 | 10 | — | — |
| | Carboxylic acid | Terephthalic acid | 1134 | 82 | 1187 | 82 | 912 | 84 |
| | component | | | | | | | |

| | | | | | | | |
|---|---|---|---|---|---|---|---|
| Bireactive | Acrylic acid | — | — | — | — | 41 | 9 |
| monomer | | | | | | | |
| Raw material | | Charged | Mass | Charged | Mass | Charged | Mass |
| monomer (V) of | | amount (g) | % *4 | amount (g) | % *4 | amount (g) | % *4 |
| vinyl resin | Styrene | — | — | — | — | 563 | 82 |
| segment | 2-Ethylhexyl acrylate | — | — | — | — | 123 | 18 |
| Esterification | Tin(II) di(2-ethylhexanoate) | 24 | 0.6 | 24 | 0.6 | 24 | 0.8 |
| catalyst | | | | | | | |
| Promoter | Gallic acid | 2 | 0.05 | 2 | 0.05 | 2 | 0.06 |
| Polymerization | | Charged | Parts by | Charged | Parts by | Charged | Parts by |
| initiator | | amount (g) | mass *5 | amount (g) | mass *5 | amount (g) | mass *5 |
| | Di-tert-butyl peroxide | — | — | — | — | 68 | 10 |

| | | | | |
|---|---|---|---|---|
| Physical | Glass transition temperature (° C.) | 61 | 58 | 61 |
| properties | Hydroxyl value (mgKOH/g) | 49 | 51 | 42 |
| | Softening point (° C.) | 97 | 102 | 108 |

*1: BPA-PO: Propylene oxide (2.2) adduct of 2,2-bis(4-hydroxyphenyl)propane
*2: Molar number when the whole amount of the alcohol component of the raw material monomer (P) is defined as 100 mol
*3: Molar ratio (% by mass) based on 100 parts by mass of the total amount of the alcohol component, the carboxylic acid component, and the acid-modified polypropylene polymer. The numerical value within the parenthesis expresses the molar number when the whole amount of the alcohol component is defined as 100 mol.
*4: Blending amount (% by mass) relative to the total amount of the raw material monomer (V)
*5: Blending amount (parts by mass) based on 100 parts by mass of the sum total of the raw material monomer (V)

### Production of Liquid Developer

### Examples 201 to 204 and 208 to 209 and Reference Example 231 (Liquid Developers 201 to 204, 208 to 209, and 231)

Using a 20-liter capacity Henschel mixer, a binder resin and an acid-modified polypropylene polymer shown in Table 4, and a colorant, “ECB-301” (phthalocyanine blue 15:3, available from Dainichiseika Color & Chemicals Mfg. Co., Ltd.) were previously stirred and mixed at a rotation number of 1,500 r/min (peripheral speed: 21.6 m/sec) for 3 minutes.

A co-rotation twin screw extruder, “PCM-30” (available from Ikegai Corporation, diameter of screw: 2.9 cm, cross-sectional area of screw: 7.06 cm²) was used. The operating condition was as follows: a barrel preset temperature of 100° C., a rotation number of screw of 200 r/min (peripheral speed: 0.30 m/sec), and a feeding rate of mixture of 10 kg/h (feeding rate of mixture per unit cross-sectional area of screw: 1.42 kg/h·cm²).

The resulting kneaded product was roll-cooled with a cooling roll, and the resultant was coarsely pulverized with a hammer mill to a size of about 1 mm. The resulting coarsely pulverized product was finely pulverized and classified with a pneumatic jet mill, “IDS” (available from Nippon Pneumatic Mfg. Co., Ltd.), to obtain toner particles having a volume median particle diameter (D₅₀) of 10 μm.

25 parts by mass of the resulting toner particles and 75 parts by mass of an insulating liquid, “ISOPAR L” (isoparaffin, available from Exxon Mobil Corporation, conductivity: 6.2×10⁻¹³ S/m, viscosity at 25° C.: 1 mPa·s) were charged in a 2-liter capacity polyethylene-made vessel. Using “T.K. ROBOMIX” (available from PRIMIX Corporation), the contents were stirred under ice-cooling at a rotation number of 7,000 r/min for 30 minutes, to obtain a dispersion having a solid content concentration of 25% by mass.

Subsequently, the resulting dispersion was subjected to wet pulverization for 4 hours with a 6 vessels-type sand mill, “TSG-6” (available from AIMEX CO., LTD.) at a rotational number of 1,300 r/min (peripheral speed: 4.8 m/sec) using zirconia beads having a diameter of 0.8 mm at a volume packing ratio of 60% by volume. The beads were removed by means of filtration, to obtain liquid developers 201 to 204, 208, 209, and 231.

### Examples 205 to 207 and Comparative Examples 201 to 202 (Liquid Developers 205 to 207 and 251 to 252)

The resin and the acid-modified polypropylene polymer were changed as shown in Table 4, and the toner particles in an amount shown in Table 4, an in-oil dispersant, “SOLSPERSE 13940” (available from Nippon Lubrizol Corporation), and an insulating liquid, “ISOPAR L” (isoparaffin, available from Exxon Mobil Corporation, conductivity: 6.2×10⁻¹³ S/m, viscosity at 25° C.: 1 mPa·s) were charged in a 2-liter capacity polyethylene-made vessel. Using “T.K. ROBOMIX” (available from PRIMIX Corporation), the contents were stirred under ice-cooling at a rotation number of 7,000 r/min for 30 minutes. There were thus obtained liquid developers 205 to 207 and 251 to 252 in the same manner as in Example 201, except that the toner particle dispersion having a solid content concentration of 25% by mass was obtained.

With respect to the liquid developers obtained in the Examples, Comparative Examples, and Reference Example, the physical properties were measured by the aforementioned methods. The results are shown in Table 4.

TABLE 4

| | | | | | | | | | | Physical properties of | | | |
|---|---|---|---|---|---|---|---|---|---|---|---|---|---|
| | | Composition of liquid developer | | | | | | | | liquid developer | | | |
| | | Toner particle | | | | | | | | | | Fixing rate of | |
| | | Binder resin | | Polymer | | | Total | | Insulating | | | PP film (%) | |
| | Liquid | | Amount | | Amount | Colorant | amount | Dispersant | liquid | | Viscosity | Corona- | |
| | developer | Resin | (parts by | Polymer | (parts by | (parts by | (parts by | (parts by | (parts by | D₅₀ | *1 | treated | Untreated |
| | No. | No. | mass) | No. | mass) | mass) | mass) | mass) | mass) | (μm) | (mPa · s) | surface | surface |
| Example 201 | 201 | A-201 | 17 | WAX-A1 | 3 | 5 | 25 | 0 | 75 | 2.1 | 9 | 100 | 100 |
| Example 202 | 202 | A-201 | 18.5 | WAX-A1 | 1.5 | 5 | 25 | 0 | 75 | 3.4 | 16 | 100 | 100 |
| Example 203 | 203 | A-201 | 17 | WAX-A2 | 3 | 5 | 25 | 0 | 75 | 2.2 | 12 | 100 | 100 |
| Example 204 | 204 | A-201 | 17 | WAX-A3 | 3 | 5 | 25 | 0 | 75 | 2.7 | 5 | 100 | 88 |
| Example 205 | 205 | A-201 | 17 | WAX-B1 | 3 | 5 | 25 | 2.5 | 72.5 | 5.4 | 75 | 100 | 100 |
| Example 206 | 206 | A-201 | 17 | WAX-B2 | 3 | 5 | 25 | 2.5 | 72.5 | 2.3 | 8 | 100 | 65 |
| Example 207 | 207 | A-201 | 17 | WAX-B3 | 3 | 5 | 25 | 2.5 | 72.5 | 2.4 | 8 | 100 | 52 |
| Example 208 | 208 | A-202 | 17 | WAX-A1 | 3 | 5 | 25 | 0 | 75 | 2.5 | 13 | 100 | 95 |
| Example 209 | 209 | A-203 | 17 | WAX-A1 | 3 | 5 | 25 | 0 | 75 | 2.3 | 8 | 100 | 100 |
| Comparative | 251 | A-201 | 17 | WAX-C | 3 | 5 | 25 | 2.5 | 72.5 | 2.5 | 10 | 10 | 0 |
| Example 201 | | | | | | | | | | | | | |
| Comparative | 252 | A-201 | 17 | WAX-fl | 3 | 5 | 25 | 2.5 | 72.5 | 2.4 | 7 | 55 | 0 |
| Example 202 | | | | | | | | | | | | | |
| Reference | 231 | A-201 | 17 | WAX-E | 3 | 5 | 25 | 0 | 75 | 2.6 | 27 | 70 | 0 |
| Example 231 | | | | | | | | | | | | | |

*1: Value at a solid content concentration of 25% by mass and at a temperature of 25° C.
WAX-A1: Polypropylene terminally modified with maleic anhydride at one terminal, “X-10065” (available from Baker Hughes Incorporated, number average molecular weight Mn 1000, melting point 90° C., acid value: 100 mgKOH/g)
WAX-A2: Polypropylene terminally modified with maleic anhydride at one terminal, “X-10088” (available from Baker Hughes Incorporated, number-average molecular weight Mn 2500, melting point 130° C., acid value: 35 mgKOH/g)
WAX-A3: Propylene/hexene copolymer terminally modified with maleic anhydride at one terminal, “X-10052” (available from Baker Hughes Incorporated, number-average molecular weight Mn 4000, melting point 80° C., acid value: 125 mgKOH/g)
WAX-B1: Maleic anhydride random graft-modified polypropylene, “PMA-T” (available from Toyobo Co., Ltd., melting point: 93° C., acid value: 17 mgKOH/g)
WAX-B2: Maleic anhydride random graft-modified polypropylene, “PMA-F2” (available from Toyobo Co., Ltd., melting point: 125° C., acid value: 17 mgKOH/g)
WAX-B3: Maleic anhydride random graft-modified polypropylene, “PMA-H3000P” (available from Toyobo Co., Ltd., melting point: 138° C., acid value: 31 mgKOH/g)
WAX-C: Unmodified polypropylene. “NP-056” (available from Mitsui Chemicals, Inc., melting point: 132° C., acid value: 0 mgKOH/g)
WAX-D: Maleic anhydride random graft-modified polyethylene, “4202E” (available from Mitsui Chemicals, Inc., melting point: 100° C., acid value: 17 mgKOH/g)
WAX-E: Polyisobutene terminally modified with maleic anhydride at one terminal, “OLOA 15500” (available from Chevron Oronite SA, melting point: −20° C., acid value: 93 mgROH/g)

With respect to the second embodiment of the present invention, it is noted from the foregoing results that the liquid developers of Examples 201 to 209 had a small particle size and had a low viscosity, and they further exhibited excellent adhesion to the PP film and exhibited favorable fixing property on not only the corona-treated surface but also the untreated surface of the PP film.

On the other hand, the liquid developer of Comparative Example 201 is low in the fixing property even on the corona-treated surface because the polypropylene is not modified with the acid. In addition, the liquid developers of Comparative Example 202 and Reference Example 231 did not substantially exhibit the fixing property on the untreated surface in the case where the acid-modified polymer contained is polyethylene or polyisobutene.

1. A liquid developer, comprising,
toner particles containing a colorant and a binder resin including a polyester resin; and
an insulating liquid, wherein
the polyester resin includes a constituent unit derived from an alcohol component and a constituent unit derived from a carboxylic acid component, and
the constituent unit derived from the carboxylic acid component of the polyester resin includes a constituent unit derived from an acid-modified product A of a polymer of an α-olefin having 3 or more and 18 or less carbon atoms.

2. (canceled)

3. The liquid developer according to claim 1, wherein the polyester resin is a resin in which the constituent unit derived from the alcohol component and the constituent unit derived from the acid-modified product A are connected with each other via an ester bond.

4. The liquid developer according to claim 1, wherein the polyester resin has a comb-shaped polymer structure in which the acid-modified product A is grafted on the polyester resin.

5. The liquid developer according to claim 1, wherein an amount of the constituent unit derived from the acid-modified product A is 1% by mass or more and 40% by mass or less in the polyester resin.

6-7. (canceled)

8. The liquid developer according to claim 1, wherein a number average molecular weight of the acid-modified product A is 400 or more and 50,000 or less.

9. The liquid developer according to claim 1, wherein the acid-modified product A is an acid-modified product resulting from modification with maleic anhydride.

10. The liquid developer according to claim 1, wherein the acid-modified product A is an α-olefin polymer resulting from modification with maleic anhydride at one terminal.

11. The liquid developer according to claim 1, wherein the acid-modified product A is an acid-modified polypropylene polymer.

12. The liquid developer according to claim 1, wherein the acid-modified product A is a polypropylene polymer having maleic anhydride randomly graft-modified thereon.

13. The liquid developer according to claim 1, wherein a volume median diameter (D₅₀) of the toner particles in the liquid developer is 0.5 μm or more and 6 μm or less.

14. The liquid developer according to claim 1, wherein a viscosity of the liquid developer at a solid content concentration of 25% by mass and at a temperature of 25° C. is 1 mPa·s or more and 50 mPa·s or less.

15. The liquid developer according to claim 1, wherein a resistance of the liquid developer at a solid content concentration of 25% by mass and at a temperature of 25° C. is 5.0×10⁹ Ω·m or more and 1.0×10¹³ Ω·m or less.

16. A method for producing a printed matter, comprising:
printing on a recording medium with the liquid developer according to claim 1, wherein
the recording medium is a polypropylene film.

17. A polypropylene film printing method, comprising:
using the liquid developer according to claim 1 as a liquid developer.

18. A method for producing a liquid developer, comprising:
melt kneading a binder resin including a polyester resin, a colorant, and an acid-modified product A of a polymer of an α-olefin having 3 or more and 18 or less carbon atoms and then pulverizing, to obtain toner particles;
dispersing the toner particles in an insulating liquid, to obtain a dispersion; and
wet pulverizing the dispersion, to obtain a liquid developer.

19. The method according to claim 18, wherein an amount of the acid-modified product A is 1 part by mass or more and 40 parts by mass or less based on 100 parts by mass of the binder resin.
